(19) United States
(12) Patent Application Publication
(10) Pub. No.: US 2012/0118138 A1
(43) Pub. Date: May 17, 2012

(54) FLUID DELIVERY SYSTEM COMPRISING A FLUID PUMPING DEVICE AND A DRIVE SYSTEM

(75) Inventors: Thierry Navarro, Gland (CH); Florent Junod, Veigy Foncenex (FR)

(73) Assignee: SWISSINNOV PRODUCT SARL, Gland (CH)

(21) Appl. No.: 13/386,559

(22) PCT Filed: Jul. 6, 2010
(86) PCT No.: PCT/IB2010/001683

§ 371 Date: Jan. 23, 2012

(30) Foreign Application Priority Data
Jul. 23, 2009 (IB) PCT/IB2009/006336
Sep. 29, 2009 (IB) PCT/IB2009/006996
Apr. 16, 2010 (IB) PCT/IB2010/000851
May 3, 2010 (IB) PCT/IB2010/001008

(51) Int. Cl. F04B 7/00; B29C 45/14; F04B 9/02

(52) U.S. Cl. 91/435; 264/254

(57) ABSTRACT

A fluid pumping device having a pump housing containing a piston chamber and a reciprocating piston, an inlet port and an outlet port allowing a fluid to enter the piston chamber during an instroke of the piston and be expelled during an outstroke. The device further having a valve switching element movably mounted against a valve base member, with a piston chamber aperture connected to the piston chamber and an inlet aperture and an outlet aperture connected respectively to the inlet and outlet ports of the fluid pumping device. The element has a grooves in the valve base member providing, a first communication between the inlet aperture and the piston chamber aperture so that fluid is sucked, into the piston chamber during part of the piston instroke, and a second communication aperture expelling fluid out of the piston chamber, through the outlet port during part of the piston outstroke.

### TECHNICAL FIELD

The invention described herein is directed to a fluid delivery system comprising a fluid pumping device and an associated drive system. The invention is further directed to a method for manufacturing the fluid pumping device. The fluid delivery system according to the invention is intended to be used in any industrial field such as the chemical or the pharmaceutical industry. This system is particularly adapted to be used as an enteral, parenteral, or IV pump in the medical industry and it is preferably used as an insulin pump given that its internal structure can easily be reduced for obtaining an ultra small and very light pump while being capable to deliver a very small bolus directly from a loadable penfill cartridge.

### BACKGROUND OF THE INVENTION

Insulin pumps are widely known in the prior art and are an alternative to multiple daily injections of insulin by an insulin syringe or an insulin pen. Insulin pumps make it possible to deliver more precise amounts of insulin than can be injected using a syringe. This supports tighter control over blood sugar and Hemoglobin A1c levels, reducing the chance of long-term complications associated with diabetes. This is predicted to result in a long term cost savings relative to multiple daily injections.

Some insulin pumps comprise internal receiving means for an insulin cylindrical penfill cartridge. US2007/0167912 describes a pump of this kind comprising a plunger engagement device mounted inside the pump to face a plunger of an insulin penfill cartridge when said cartridge is inserted into the receiving means of the pump. The plunger engagement device is configured to attach to the cartridge plunger when urged together. This device is connected to a flexible piston rod arranged to push the cartridge plunger inside the penfill cartridge along a preset distance so that an insulin dose can be expelled out of the cartridge. A major drawback of this pump lies on the complexity of the driving mechanism that actuates the piston rod. The mechanism of this pump is made of numerous components whose arrangement inside the pump makes it difficult to minimize its size. As an insulin pump needs to be worn most of the time, pump users may find it uncomfortable or unwieldy. Besides, assembling all the parts of the pump as described therein is a time-consuming process which further requires strenuous quality control as numerous interacting parts increase the risk of failure making the pump less reliable.

Another disadvantage of this kind of pump occurs when the piston pushes directly the cartridge plunger inside the penfill cartridge along its longitudinal axis, the plunger tending to move irregularly along said axis as an important, irregular and uncontrolled friction exists. This phenomenon is better known as the so-called “stick slip” effect and has a direct impact on the pump accuracy.

These disadvantages have been solved, to a large extend, by a volumetric pump mechanism as described in WO2006056828. This volumetric pump comprises a first and a second piston which are mounted inside a first and a second hollow cylindrical part (chamber) to be movable along the longitudinal axis of said cylindrical parts, while being synchronized to each other such that a specific amount of fluid is sucked in during the instroke of the first piston, while the same amount of fluid is expelled during the outstroke of the second piston. The first and the second hollow cylindrical part are assembled end-to-end facing each other to form a housing. A valve disc (valve system), which comprises an inlet and an outlet port connected respectively to an inlet and an outlet T-shaped channel, is mounted between the first and second pistons inside the housing and is arranged to be animated by a combined bidirectional linear and angular movement which couples the pistons strokes with the movement of the valve system. More precisely, linear movements of the disc produce a to-and-fro sliding of the cylindrical housing along the axis of the pistons causing an alternate instroke of the first and second pistons followed by an alternate outstroke of the first and second pistons inside their respective chamber while its angular movement synchronizes the first piston chamber filling phase with the second piston releasing phase. This synchronization is achieved by an inlet and outlet T-shaped channel located inside the valve disc which connects alternately the inlet port to the first and second chambers, and the first and second chambers to the outlet port when said channels overlap alternately an inlet aperture and an outlet aperture located across the diameter of both cylindrical parts adjacent to the lateral sides of the disc. The flow of the fluid released by this pump is virtually continuous.

A major drawback of this volumetric pump is that the inlet and outlet apertures, arranged to be aligned alternately with the inlet and outlet T-shaped channels, are located across the diameter of both cylindrical parts adjacent to the lateral sides of the valves disc. As a result, the volume reduction of the first and second chambers is limited to the size of the apertures below which it would be insufficient to guarantee a normal flow delivery.

Another drawback of this pump stems from the fact that the inlet and outlet channels are mounted on the valve disc to which a linear and angular movement is imparted. As a result, the inlet and outlet ports and the tubes connected thereto are continuously moving under working condition which may be troublesome for pump users who may find it uncomfortable to wear.

### SUMMARY OF THE INVENTION

An aim of the present invention is to simplify the internal mechanism of a fluid pumping device in order to reduce its dimensions, to improve its reliability as well as its accuracy.

This aim is achieved by a fluid pumping device comprising a housing containing at least one piston chamber and at least one piston arranged to be linearly actuable to move back and forth inside the piston chamber, at least one inlet port and at least one outlet port arranged so that a fluid can be sucked through the inlet port into the piston chamber during an instroke of the piston and expelled from the piston chamber through the outlet port during an outstroke of the piston. The fluid pumping device further comprises a valve system which has a valve-switching element that is movably mounted against a valve base member. Said valve base member comprises at least one piston chamber aperture connected to the piston chamber and at least one inlet aperture and at least one outlet aperture connected respectively to the inlet and outlet ports of the fluid pumping device. The valve-switching element comprises at least one groove or other recess arranged to move against the valve base member such that said groove or recess creates a first communication allowing leakage between the inlet aperture and the piston chamber aperture so that fluid is sucked from the inlet port, through the groove or recess, into the piston chamber during at least a part of the piston instroke, while said groove or recess creates a second communication allowing leakage between the piston chamber aperture and the outlet aperture so that fluid is expelled out of the piston chamber, through the groove or recess and the outlet port during at least a part of the piston outstroke.

Another aspect of the present invention is to provide a drive system adapted to impart rotating and/or to-and-fro movements to the valve-switching element relative to the valve base member of the fluid pumping device as set forth in the appended claims in order to obtain an operable fluid delivery system.

A further aspect of the present invention is to provide a portable pump comprising a case unit which has a removable lid. The case unit incorporates a fluid pumping device and a drive system according to the invention, a battery, and a compartment configured for accommodating a cartridge containing a therapeutic agent. The fluid pumping device comprises a needle and is connected to the bottom part of the removable lid such that the needle pierces the cartridge when the latter is pushed inside said compartment.

A yet further aspect of the present invention is to provide a patch for application to the skin of a human body comprising:
a disposable receiving unit having a disposable case that incorporates the fluid pumping device according to the invention;
an adhesive membrane which is part of the disposable receiving unit; and,
a case unit that is engaged on the disposable receiving unit and that incorporates the drive system according to the invention, a battery, and a compartment configured for accommodating a cartridge containing a therapeutic agent.

An even further aspect of the present invention is to provide a fluid delivery system for mixing different types of fluid. This fluid delivery system comprises multiple inlet ports and at least one outlet port, wherein each inlet and outlet ports is independently selectable to be in fluid communication with the piston chamber. The valve base member comprises for this purpose a corresponding plurality of inlet and outlet apertures. Each inlet aperture is connected to one of the inlet ports of the fluid delivery system by means of an inlet channel, while each outlet aperture is connected to the corresponding outlet port of said system by means of an outlet channel. The valve base member further comprises at least one piston chamber aperture that communicates with the piston chamber. Any inlet port is selectable by imparting a movement to the valve switching element relative to the valve base member so that the groove overlaps the corresponding inlet and piston chamber apertures.

Finally, a last aspect of the present invention is to provide an injection moulding process for manufacturing the fluid pumping device in a minimum number of steps so as to reduce its production costs and to improve its reliability. This process comprises the following steps: (a) injecting a mouldable plastic material capable of forming a substantially rigid element into a mould cavity assembly for obtaining the housing of the fluid pumping device, said housing comprising a part adapted to receive the valve base member; (b) placing a seal mould matrix designed to reproduce the inlet, outlet and piston chamber(s) cavities on said part; and (c) injecting into said matrix a mouldable rubber-elastic material in a flowable state, the rubber-elastic material polymerizing in the mould matrix while being bonded to the housing of the fluid pumping device to form the valve base member.

### BRIEF DESCRIPTION OF THE DRAWINGS

The invention will be better understood thanks to the following detailed description of several embodiments with reference to the attached drawings, in which:

FIG. 1 shows a see-through perspective view of a fluid pumping device according to a first embodiment of the invention;

FIG. 2 shows a see-through perspective bottom view of the fluid pumping device of FIG. 1;

FIG. 3 shows a see-through bottom view of the fluid pumping device of FIG. 1;

FIG. 4 shows an exploded view of a part of the valve system of the fluid pumping device of FIG. 1;

FIG. 5 shows an elevational view of a fluid delivery system comprising the fluid pumping device of FIG. 1, a drive system and a penfill cartridge;

FIG. 6 shows a top view of FIG. 5;

FIG. 7 shows a cross-sectional view of the fluid delivery system taken on the line A-A in FIG. 5;

FIG. 8 shows a cross-sectional view of the fluid delivery system taken on the line D-D in FIG. 6;

FIG. 9 shows a cross-sectional view of the fluid delivery system taken on the line B-B in FIG. 5;

FIG. 10 shows a cross-sectional view of the fluid delivery system taken on the line C-C in FIG. 5;

FIG. 11 shows a perspective view of the drive system;

FIG. 12 shows an exploded view of a portable pump comprising a case unit, the penfill cartridge and a removable lid securely holding on its bottom part the fluid pumping device of FIG. 1;

FIG. 13 shows a perspective view of a patch for application to the skin of a human body incorporating the fluid delivery system of the first embodiment;

FIG. 14 shows a perspective view of a system adapted to connect the patch of FIG. 13 to a cannula;

FIG. 15 shows a disposable receiving unit of the patch of FIG. 13 comprising means to receive the drive system and the penfill cartridge of FIG. 8, and a casing incorporating the fluid pumping device of FIG. 1;

FIG. 16 shows a perspective view of the patch of FIG. 13 without the disposable receiving unit;

FIG. 17 shows a perspective view of a patch according to a variant of FIG. 13;

FIG. 18 shows a perspective view of an automatic device for inserting the cannula into the patient body;

FIG. 18a shows a partial cross-sectional view of FIG. 18;

FIG. 19 shows the automatic device of FIG. 18 mounted on the patch of FIG. 13;

FIG. 20a shows a front view of the upper part of the fluid delivery system just before the beginning of a pumping cycle when there is no pumping movement;

FIG. 20a′ shows cross-sectional views taken respectively on the lines A-A, B-B and C-C in FIG. 20a;

FIG. 20b shows a similar view of FIG. 20a during a piston instroke of the fluid delivery system;

FIG. 20b′ shows cross-sectional views taken respectively on the lines A-A, B-B and C-C in FIG. 20b;

FIG. 20c shows a similar view of FIG. 20a at the end of the piston instroke of the fluid delivery system;

FIG. 20c′ shows cross-sectional views taken respectively on the lines A-A, B-B and C-C in FIG. 20c;

FIG. 20d shows a similar view of FIG. 20a during a piston outstroke of the fluid delivery system;

FIG. 20d′ shows cross-sectional views taken respectively on the lines A-A, B-B and C-C in FIG. 20d;

FIG. 21 shows a see-though perspective view of a fluid pumping device according to a variant of the first embodiment;

FIG. 22 shows a bottom perspective view of FIG. 21;

FIG. 23 shows a top view of FIG. 21;

FIG. 24 shows a cross-sectional view taken on the line A-A in FIG. 23;

FIG. 25 shows an exploded view of a fluid pumping device and a drive system of a fluid delivery system according to a second embodiment of the invention;

FIG. 26 shows a perspective view of the fluid delivery system of FIG. 25;

FIG. 27 shows an exploded view of the fluid pumping device of FIG. 25;

FIG. 28 shows an elevational view of the fluid delivery system of FIG. 26;

FIG. 29 shows a cross-sectional view of the fluid pumping device taken on the line A-A in FIG. 28;

FIG. 30 shows a top view of FIG. 28;

FIG. 31 shows a partial cross-sectional view of the fluid delivery system taken on the line B-B in FIG. 30;

FIG. 32 shows a perspective view of a fluid pumping device and a drive system of a fluid delivery system according to a third embodiment of the invention;

FIG. 33 shows a bottom view of FIG. 32;

FIG. 34 shows an elevational view of FIG. 30;

FIG. 35 shows a cross-sectional view of the fluid delivery system taken on the line A-A in FIG. 34;

FIG. 36 shows a top view of FIG. 32;

FIG. 37 shows a cross-sectional view of the fluid delivery system taken on the line B-B in FIG. 36;

FIG. 38 shows an exploded bottom view of the fluid pumping device of FIG. 32;

FIG. 39 shows an exploded top view of the fluid pumping device of FIG. 32;

FIG. 40 shows a see-through perspective view of a fluid pumping device comprising a first and a second piston according to a fourth embodiment of the invention;

FIG. 41 shows a see-through bottom view of FIG. 40;

FIG. 42 shows an exploded view of a part of the valve system of the fluid pumping device of FIG. 40;

FIG. 43 shows a perspective view of a fluid delivery system comprising the fluid pumping device of FIG. 40 and a drive system;

FIG. 44 shows a top view of FIG. 43;

FIG. 45 shows a cross-sectional view of the fluid delivery system taken on the line A-A in FIG. 44;

FIG. 46 shows a cross-sectional view of the fluid delivery system taken on the line B-B in FIG. 44;

FIG. 47a shows a front view of the upper part of FIG. 43 just before the beginning of a pumping cycle when there is no pumping movement;

FIG. 47a′ shows cross-sectional views of the fluid delivery system taken respectively on the lines A-A, B-B and C-C in FIG. 47a;

FIG. 47b shows a similar view of FIG. 47a during an instroke of the first piston and an outstroke of the second piston;

FIG. 47b′ shows cross-sectional views of the fluid delivery system taken respectively on the lines A-A, B-B and C-C in FIG. 47b;

FIG. 47c shows a similar view of FIG. 47a at the end of the first piston instroke and the second piston outstroke;

FIG. 47c′ shows cross-sectional views of the fluid delivery system taken respectively on the lines A-A, B-B and C-C in FIG. 47c;

FIG. 47d shows a similar view of FIG. 47a during an outstroke of the first piston and an instroke of the second piston;

FIG. 47d′ shows cross-sectional views of the fluid delivery system taken respectively on the lines A-A, B-B and C-C in FIG. 47d.

FIG. 48 shows a schematic view of a valve system for a fluid pumping device according to a fifth embodiment of the invention;

FIG. 49 shows a schematic view of a valve system for a fluid pumping device according to a sixth embodiment of the invention;

FIG. 50 shows a schematic view of the valve system for a fluid pumping device according to a seventh embodiment of the invention;

FIG. 51 shows a see-though perspective view of a fluid pumping device according to an eighth embodiment of the invention;

FIG. 52 shows a see-though perspective view of a cylindrical valve holder inside a pump housing of the fluid pumping device of FIG. 51;

FIG. 53 shows a perspective view of the cylindrical valve holder;

FIG. 54 shows a see-though perspective view of the pump housing inside which is axially mounted a piston;

FIG. 55 shows an axially cross-sectional view of FIG. 54;

FIGS. 56, 57 and 58 show see-though perspective views of the fluid pumping device according to a variant of FIGS. 51 to 55.

FIG. 59 shows a perspective view of a valve system comprising seal elements on the valve-switching element according to a ninth embodiment of the invention;

FIG. 60 shows a perspective view of a fluid delivery system comprising a fluid pumping device with multiple inlets ports and its drive system according to a tenth and last embodiment of the invention;

FIG. 61 shows a perspective view of the drive system of FIG. 60;

FIG. 62 shows a top view of the fluid pumping device of FIG. 60;

FIG. 63 shows a side view of FIG. 62;

FIG. 64 shows a cross-sectional view of the fluid pumping device taken on the line A-A in FIG. 62;

FIG. 65 shows a cross-sectional view of the fluid pumping device taken on the line B-B in FIG. 62;

FIG. 66 shows a cross-sectional view of the fluid pumping device taken on the line C-C in FIG. 63;

FIG. 67 shows a perspective view of the fluid pumping device with its valve system;

FIG. 68 shows a perspective view of the fluid pumping device with its valve system according to a variant.

### DETAILED DESCRIPTION OF EMBODIMENTS OF THE INVENTION

### First Embodiment of the Invention

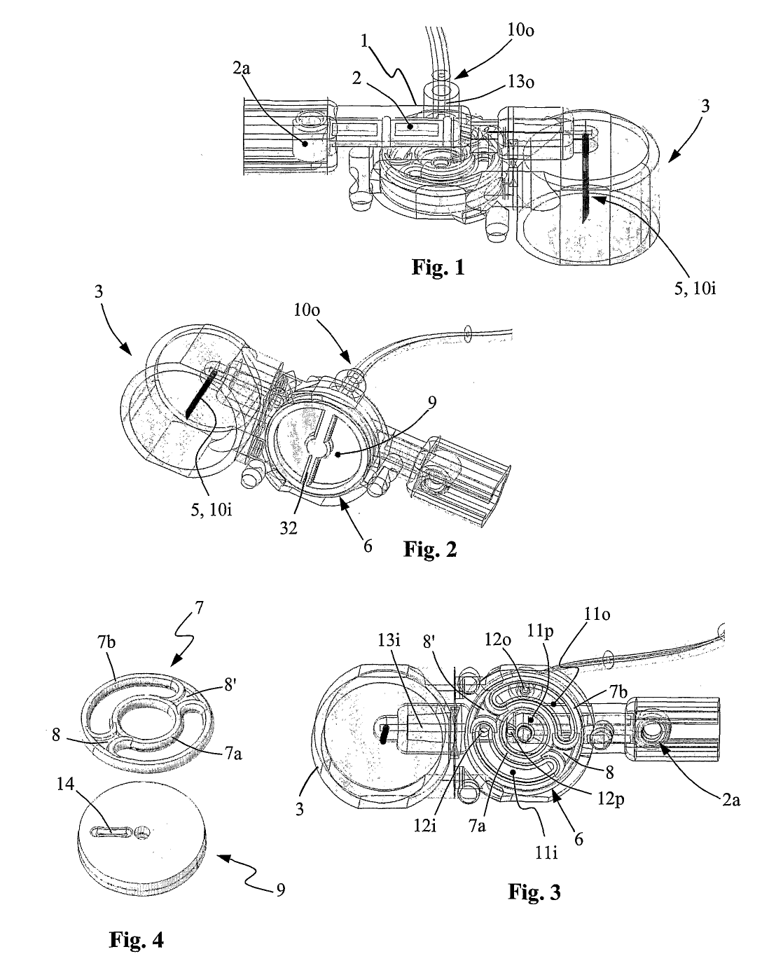

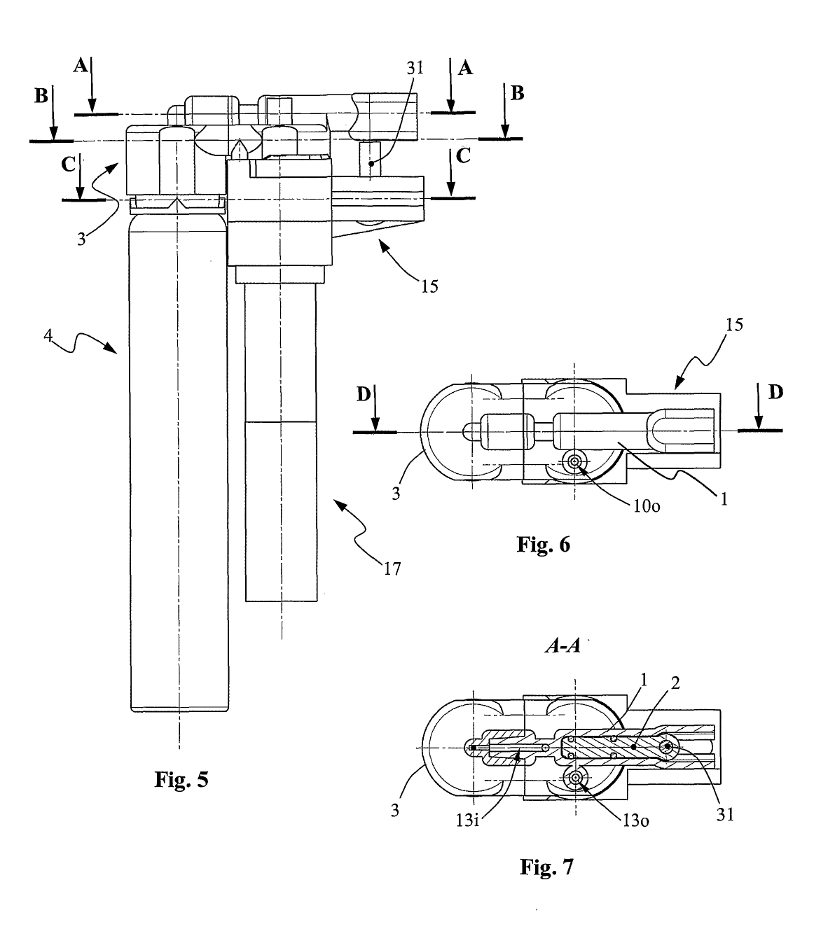

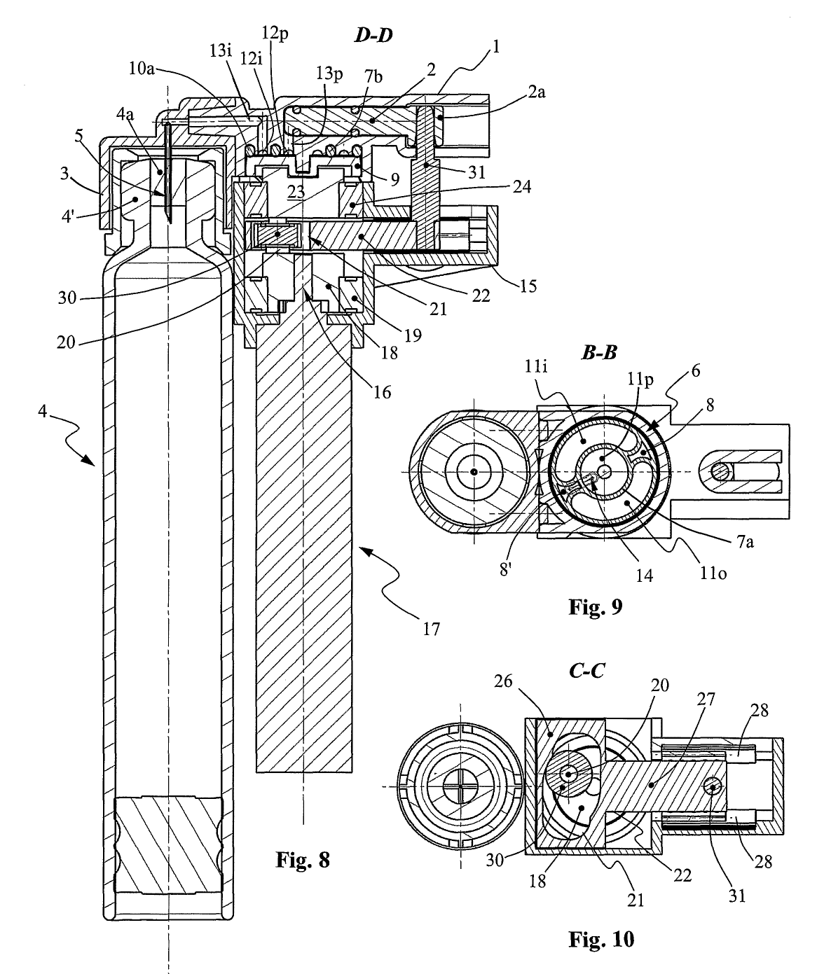

According to the first embodiment of the present invention as shown in FIGS. 1 to 12, the fluid delivery system comprises a preferable disposable fluid pumping device coupled with a drive system. As shown in FIGS. 1 to 3, the fluid pumping device comprises a plastic molded housing 1 having a piston chamber inside which a piston 2 is mounted so as to be movable back and forth inside said chamber, and a cylindrical cap 3 for receiving the head 4′ of a penfill cartridge 4 (FIG. 8). A needle 5 is axially mounted inside the cylindrical cap 3 and is adapted to pierce the cartridge head 4′ when the latter is urged into said cap 3. For this purpose, an inner part 4a of the cartridge head 4′ is made of a soft material to ease the introduction of the needle 5 into the cartridge content.

The bottom part of the fluid pumping device comprises a cylindrical recess 6 (FIG. 3) that has a substantially flat bottom surface against which a seal element in the form of a gasket 7 (FIG. 4) is bonded to. Said gasket 7 comprises two concentric rings, namely an inner ring 7a and an outer ring 7b, attached together by a first and a diametrically opposed second sealing part 8, 8′. A valve-switching element 9, which is a disc, is rotatably mounted on gasket 7, which can be seen as representing the valve base member, to open and close in turn an inlet and an outlet port 10i, 10o of the fluid pumping device during a pumping cycle.

As shown for example in FIG. 3, the gasket 7 is shaped as to obtain arcuate inlet and outlet cavities 11i, 11o symmetrically opposed with respect to the rotation axis of disc 9, and a circular cavity 11p (referred to hereafter as the piston chamber cavity) axially centred on said axis. Inlet and outlet cavities 11i, 11o are defined by inner ring 7a, outer ring 7b and the two sealing parts 8, 8′ of the gasket 7, while circular chamber cavity 11p is defined by the gasket inner ring 7a.

Referring to FIGS. 3, 8 and 9, cylindrical recess 6 comprises inlet, outlet and piston chamber apertures 12i, 12o, 12p which are located inside respectively the inlet, outlet and piston chamber cavities 11i, 11o, 11p defined by the gasket 7. The Inlet and outlet apertures 12i, 12o are in fluid communication respectively with the needle 5 (which can be seen as the inlet port 10i of the fluid pumping device), by means of an L-shaped inlet channel 13i (FIG. 8) and with the outlet port 10o by means of an outlet channel 13o (FIGS. 1 and 7), while the piston chamber aperture 12p is in fluid communication with the piston chamber by means of a piston chamber channel 13p arranged to extend parallel to one part of the inlet channel 13i from the piston chamber to the piston chamber cavity 11p as shown in FIG. 8.

As shown in FIGS. 4 and 9, a rectilinear groove 14 is arranged on disc 9 to extend radially to both sides of the gasket inner ring 7a. Disc 9 is rotatably actuable such that groove 14 moves along and extends across a part of the inner ring 7a that is adjacent to the piston chamber cavity 11p and the arcuate inlet cavity 11i during a piston instroke, while groove 14 moves along and extends across a part of the inner ring 7a that is adjacent to the piston chamber cavity 11p and the arcuate outlet cavity 11o during a piston outstroke. As a result, the piston chamber is in fluid communication with the inlet port 10i of the fluid pumping device during a piston instroke, as rotation of disc 9 creates a first communication allowing leakage between the inlet cavity 11i and the piston chamber cavity 11p, while the piston chamber is in fluid communication with the outlet port 10o of the fluid pumping device during a piston outstroke, as rotation of disc 9 creates a second communication allowing leakage between the piston chamber cavity 11p and the outlet cavity 11o. Thus, the valves system is actuated as a function of the angular movement of disc 9.

Referring now to FIGS. 8 to 10, the drive system of the fluid pumping device comprises a supporting structure 15 having a lower part adapted to receive a rotary shaft 16 of a motor 17. A first rotatable element 18 is coaxially mounted on shaft 16 and is laterally secured by a first ball bearing assembly 19. The lower part of a second shaft 20 is mounted eccentrically on rotatable element 18 and extends vertically therefrom through a substantially rectangular-shaped aperture 21 of a T-shaped sliding tray 22 to have its upper part connected eccentrically to a second rotatable element 23 that is axially aligned with first rotatable element 18 and laterally secured by a second ball bearing assembly 24. The T-shaped sliding tray 22 is arranged on the supporting structure 15 to be actuable by to-and-fro linear movements in a direction perpendicular to the rotating axis of rotary shaft 16.

For this purpose, as shown in FIG. 10, the T-shaped sliding tray 22 comprises a first rectangular part 26 extending perpendicular to a second rectangular part 27. The first part 26 comprises the substantially rectangular-shaped aperture 21 while both lateral sides of the second part 27 rest on two rails 28 secured to the supporting structure 15 by any suitable means. A ball bearing assembly 30 is fitted around the eccentric shaft 20 inside the aperture 21 to impart said to-and-fro linear movements to the sliding tray 22 when the eccentric shaft 20 rotates. A driving shaft 31 is arranged to protrude vertically from the second rectangular part 27 of the sliding tray 22 through the piston head 2a (FIG. 8) in order to impart to-and-fro linear movements to the piston 2 inside its chamber.

Aperture 21 of the sliding tray 22 is shaped as to have a specific contour such that said sliding tray 22 is actuated when the ball bearing 30 moves along the contour of aperture 21 to produce a controlled pumping cycle over the valve switching cycle.

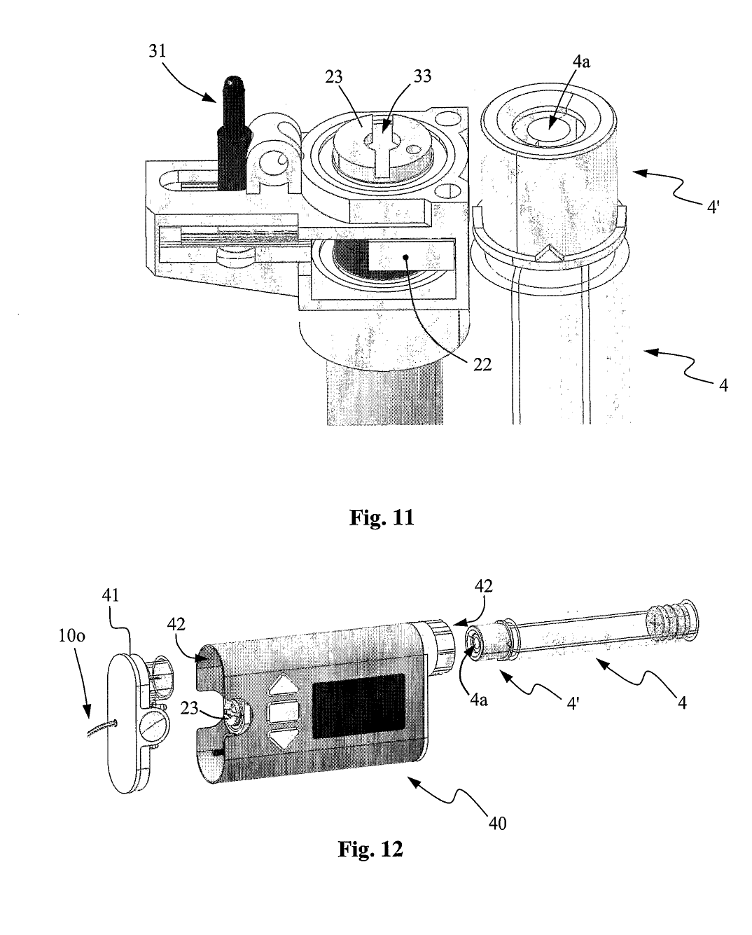

With reference to FIG. 2, the bottom part of disc 9 comprises a rectilinear bulge 32 extending along its entire diameter and having a round-shaped part centred on the disc rotation axis. This bulge 32 is adapted to be fitted in a corresponding groove 33 located on the upper part of the second rotatable element 23 of the drive system (FIG. 11). Disc 9, which comprises the rectilinear groove 14, is thus continuously rotating at controlled speed through an angle of 360° during a pumping cycle. Said groove 14, which extends radially to both sides of the gasket inner ring 7a, is therefore arranged to move along the entire circumference of said inner ring 7a during a pumping cycle (FIG. 9), thereby creating a communication allowing leakage between the piston chamber, and in turn the inlet and outlet ports 10i, 10o of the fluid pumping device.

As shown in FIG. 12, the fluid pumping device and its drive system according to this first embodiment of the invention can be integrated inside a portable pump in the form of a case unit 40. This case unit 40 comprises a disposable removable lid 41 securely holding on its bottom part the disposable fluid pumping device as described above and illustrated particularly in FIG. 1. The drive system is mounted inside the case unit 40 so that its piston driving shaft 31 is inserted through the piston head 2a and its second rotatable element 23 is connected to the disc 9 of the fluid pumping device when the lid 41 is securely fitted on the case unit 40. The latter further comprises a compartment 42 configured for accommodating the penfill cartridge 4 containing a therapeutic agent such as insulin. Said compartment 42 is arranged to receive at one end the cylindrical cap 3 of the fluid pumping device. The soft inner part 4a of the cartridge head 4′ is thus pierced by the needle 5 axially mounted inside the cap 3, when the penfill cartridge 4 is inserted inside its holding unit 42 and its head 4′ is urged into said cap 3.

The penfill cartridge can be replaced by any fillable reservoir directly integrated in a disposable part or connectable to said disposable part of the fluid delivery system. Such reservoir can be filled by any means (e.g. syringe, filing station) through an aperture on the reservoir. The type of reservoir is not limited in any sense and might have for example a filing port and an expelling port. Said reservoir can be made of rigid parts comprising for instance a cylinder and a removable cap or it can be an inflatable bag. Moreover, the fluid delivery system can contain several reservoirs which can have optionally valves components for controlling the flow of liquid from each reservoir when in operation.

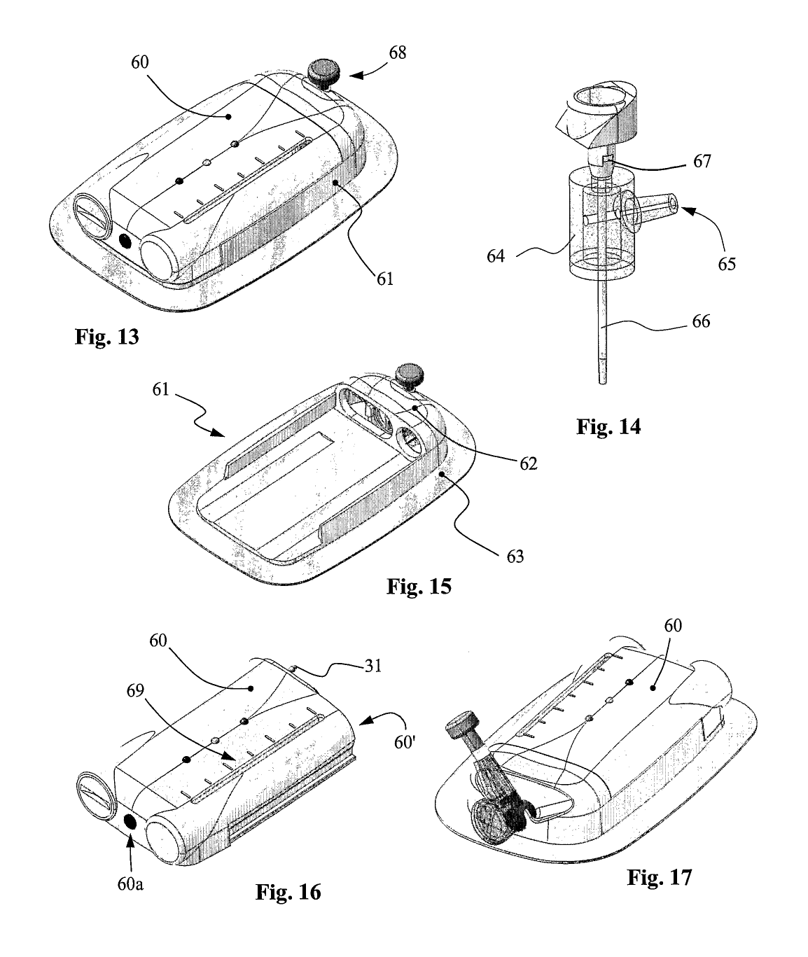

As shown in FIGS. 13 to 17 and 19, the disposable fluid pumping device can be integrated in a waterproof wearable patch pump. In this configuration, a reusable driving unit 60 incorporates the drive system of the fluid pumping device, a battery 79 (FIG. 19), and a compartment 60′ configured for accommodating the penfill cartridge. As shown for example in FIG. 16, a slot 69 is arranged along said compartment 60′ in correspondence with a scale so that the level of fluid in the cartridge 4 can be constantly monitored. The driving unit 60 further comprises a water-repellent filter 60a through which only air can pass to avoid depression inside the unit. The latter is adapted to be mounted inside a disposable receiving unit 61 that comprises a case pump 62 incorporating the fluid pumping device of this first embodiment, and an adhesive membrane 63 adapted to be stuck on a part of a patient body. FIG. 14 shows a piece 64 that is adapted to be mounted inside the case pump 62 to connect a tube 65 to the outlet port 10o of the fluid pumping device

(FIG. 19). A cannula needle 66 is axially and slidably mounted inside this piece 64 and its upper part is connected to a locking device 67. The cannula needle is inserted into the skin when a knob 68 (FIG. 13) connected to the upper end of said cannula is pressed, whereupon the locking device 67 is clipped to a corresponding part (not shown) located inside the case pump 62 to hold in place the cannula 66 while the needle is withdrawn by pulling the knob 68. FIG. 17 shows a variant of the patch pump which comprises a system which allows controlling the depth of the insertion of the cannula into the skin by adapting its angle of insertion.

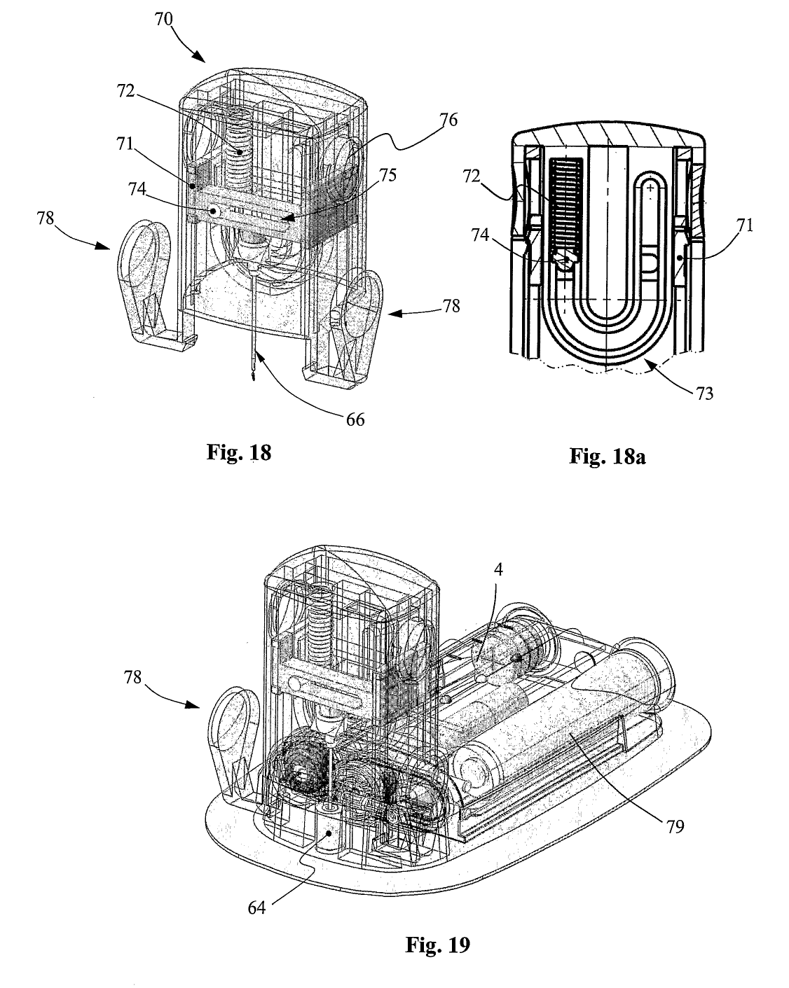

FIG. 18 shows an automatic device for inserting the cannula into the skin. This device comprises a housing 70 inside which is slidably mounted a tray 71 actuable along a vertical axis by a spring 72 arranged to expand inside a U-shaped part 73. The cannula needle 66 is realisably connected to the bottom of the tray 71. One end of the spring 72 is connected to a rod 74 that is arranged across the tray 71 to move along two longitudinal slots 75 performed on both longitudinal sides of said tray 71 as the spring 72 expands along the entire U-shaped part 73. Two push buttons 76 are located on both lateral sides of the automatic device to release tray 71 when actuated. The automatic device can easily be fitted and secured on the case pump 62 by applying a small pressure. The two push buttons 76 are then pressed together, thereby releasing the tray 71 which is actuated downwards along with the cannula 66 by the expansion of the spring 72 to the point the rod 74 reaches the bottom of the U-shaped part, whereupon the cannula has been inserted into the skin at the desired depth and the locking device 67 is clipped to a corresponding part (not shown) located inside the case pump to hold in place the cannula. At this stage, the spring 72 further expands inside the U-shaped part and pushes the tray 71 upwards, thereby withdrawing the needle from the cannula 66. The automatic device is then removed from the patch pump by simply pressing simultaneously two releasing means 78 arranged on both lateral sides of said device.

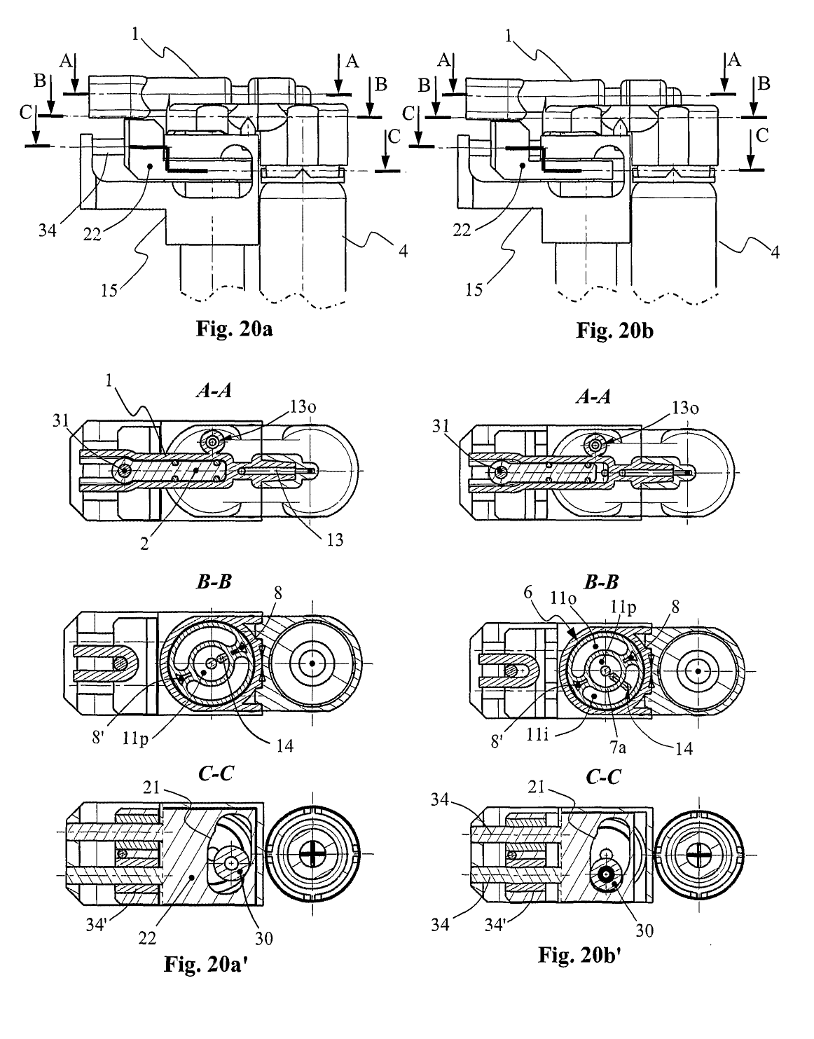

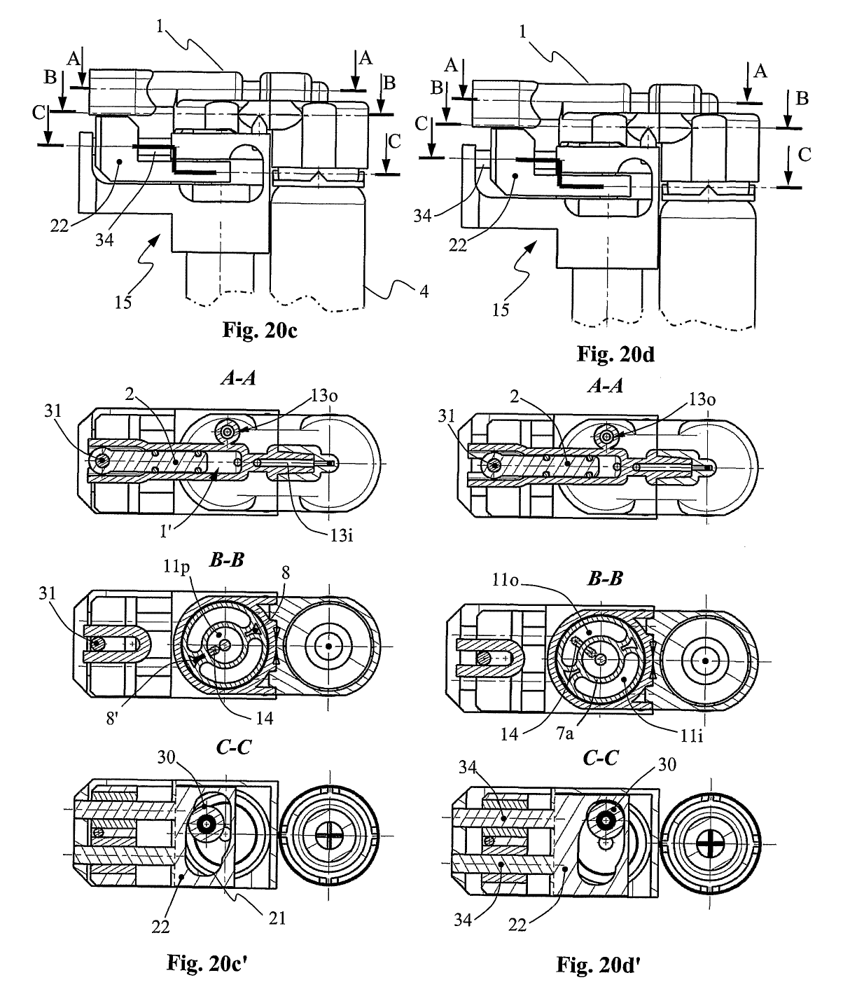

Detailed description of the fluid delivery system comprising the fluid pumping device and the drive system according to this first embodiment as it goes through the principal phases of a pumping cycle will now be described particularly with reference to FIGS. 20a to 20d. In these Figures, the drive system slightly differs from the drive system illustrated by FIGS. 8 to 10 by the shape of the supporting structure 15 and the sliding tray 22 as well as by the sliding means which consist of two rods 34 protruding parallel to each other and perpendicular to one lateral side of the supporting structure 15. These rods 34 are slidably adjusted inside two corresponding linear bearings 34′ mounted on one side of sliding tray 22 (cross-sectional view C-C of FIG. 20b′).

FIG. 20a and its corresponding cross-sectional views (FIG. 20a′) show the fluid delivery system just before the beginning of a pumping cycle when there is substantially no movement of the piston 2 and when the switching of the valves occurs. At this stage of the pumping cycle, the sliding tray 22 has been pushed by the ball bearing 30 to one of its farthest lateral positions (cross-sectional view C-C of FIG. 20a) and the rectilinear groove 14 of the disc 9 is angularly positioned to extend radially under the first sealing part 8 of the gasket 7 (cross-sectional view B-B of FIG. 20a). In this configuration, the piston chamber is entirely sealed from the inlet and outlet ports 10i, 10o of the fluid delivery system.

Switching of the valves is performed by rotation of the disc 9 which brings its rectilinear groove 14 from one side to the other side of the first sealing part 8 of gasket 7, whereupon said groove 14 creates a communication allowing leakage between arcuate inlet cavity 11i and piston chamber cavity 11p in order to connect the piston chamber to the inlet port of the fluid delivery system.

From this instant, the ball-bearing 30 is in contact with the border of aperture 21 (cross-sectional view C-C of FIG. 20b) and pushes backwards the tray 22 which causes simultaneously an instroke of the piston 2 by means of the piston driving shaft 31 (cross-sectional view A-A of FIG. 20b), while the rectilinear groove 14 of disc 9 extends radially to both sides of the inner ring 7a and moves along a part thereof adjacent to both arcuate inlet cavity 11i and piston chamber cavity 11p when disc 9 rotates through an angle of approximately 150° (cross-sectional view B-B of FIG. 20b). During this rotation, the L-shaped inlet channel 13i is permanently connected to the piston chamber channel 13p of the fluid pumping device as shown in FIG. 8. As a result, a therapeutic agent, such as insulin, contained in the penfill cartridge 4 is sucked through the needle 5, passing in turn through L-shaped inlet channel 13i, arcuate inlet cavity 11i, rectilinear groove 14, piston chamber cavity 11p and piston chamber channel 13p to fill the piston chamber.

FIG. 20c and its corresponding cross-sectional views show the fluid delivery system at the end of the piston instroke when there is substantially no movement of the piston 2 and the valve switching occurs. At this stage of the pumping cycle, the sliding tray 22 has been pushed by the ball bearing 30 to the other of its farthest lateral positions (cross-sectional view C-C of FIG. 20c) and the rectilinear groove 14 of disc 9 is angularly positioned to extend radially under the second sealing part 8′ of gasket 7 (cross-sectional view B-B of FIG. 20c). In this configuration, the piston 2 is entirely sealed from the inlet and outlet ports 10i, 10o of the fluid delivery system.

Switching of the valves is performed by rotating the disc 9 to bring its rectilinear groove 14 from one side to the other side of the second sealing parts 8′ of gasket 7, whereupon said groove 14 creates a communication allowing leakage between arcuate outlet cavity 110 and piston chamber cavity 11 p in order to connect the piston chamber 1′ to the outlet port 100 of the fluid delivery system.

From this instant, the ball-bearing 30 is in contact with the border of aperture 21 and pushes forwards the tray 22 which causes an outstroke of the piston 2 by means of the piston driving shaft 31 (cross-sectional view A-A of FIG. 20d), while the rectilinear groove 14 of disc 9 extends radially to both sides of the inner ring 7a and moves along a part thereof adjacent to both arcuate outlet cavity 110 and piston chamber cavity 11p when disc 9 further rotates through an angle of approximately 150° (cross-sectional view B-B of FIG. 20d). During this rotation, the piston chamber channel 13p is permanently connected to outlet port 10o of the fluid pumping device. As a result, the therapeutic agent is expelled from the piston chamber passing in turn trough piston chamber channel 13p, piston chamber cavity 11p, rectilinear groove 14, arcuate outlet cavity 11o and outlet channel 13o. At this point, another pumping cycle begins as described above.

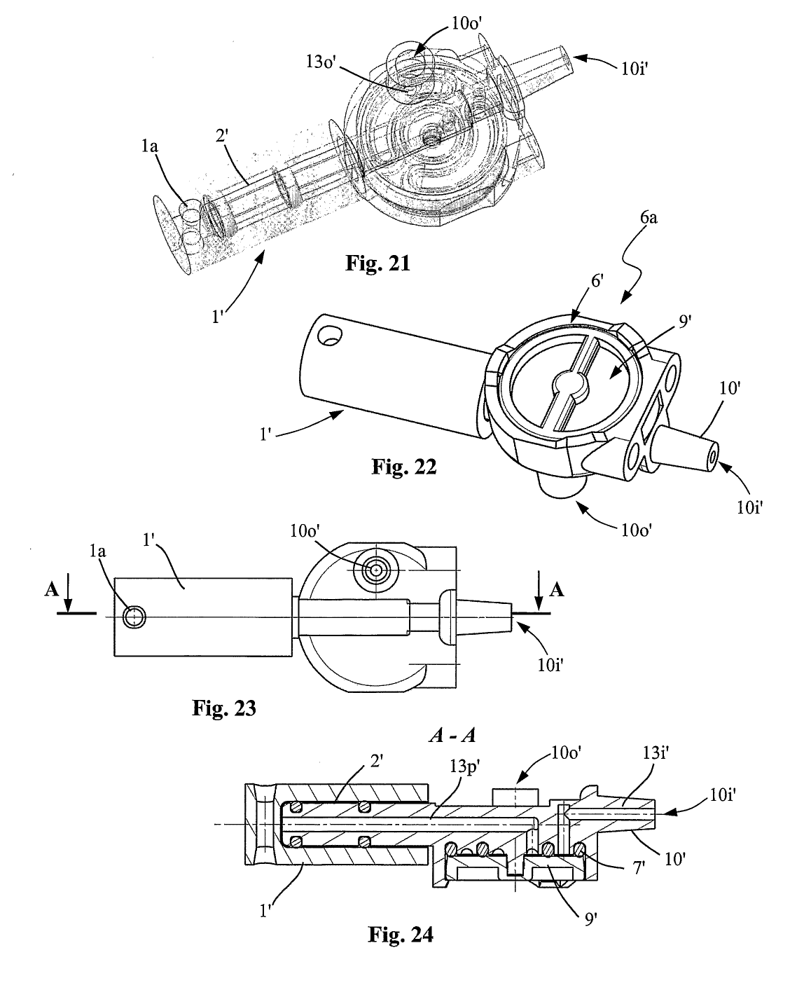

FIGS. 21 to 24 show a fluid pumping device wherein a cylindrical housing 1′ is arranged to be actuable by to-and-fro linear movements along a stationary piston 2′ according to a variant of the first embodiment of the invention. More specifically, the fluid pumping device comprises a substantially round-shaped part 6a having a circular recess 6′ and wherein a gasket 7′ is arranged on its bottom part to obtain a valve base member. A valve-switching element in the form of a disc 9′ is rotatably mounted to move against the gasket 7′ inside said recess 6′. The general configuration of the gaskets of the fluid pumping device according to this variant is shown in FIG. 21. The disc 9′ and the gasket 7′ are identical to the corresponding parts of the first embodiment (FIG. 4). The round-shaped part 6a of the fluid pumping device comprises a cylindrical extension 2′ acting as the piston and along which is movably mounted the cylindrical housing 1′. The latter comprises near its distal end a through-hole 1a adapted to receive a driving shaft (not shown). The fluid pumping device according to this variant can therefore be driven by the drive system as described in the first embodiment of the invention to obtain an operable fluid delivery system.

As shown in FIG. 24, the cylindrical extension 2′ comprises an axial piston chamber channel 13p′ that communicates at one end with the piston chamber and at the other end with the valve base member. A nose 10′ is arranged to extend from the round-shaped part 6a of the fluid pumping device opposite the piston 2′ and comprises a T-shaped inlet channel 13i′ that communicates with the valve base member. In operation of the above described fluid delivery system, a pumping cycle is achieved in the same manner as for the fluid delivery system as described in the first embodiment. A fluid is sucked from a inlet port 10i′, passing in turn through the inlet channel 13i′, a groove arranged on the disc (not shown), and the piston chamber channel 13p′ to fill the piston chamber when the piston housing 1′ is actuated to move along the piston 2′ away from the round-shaped part 6a of the fluid pumping device (piston instroke), while said fluid is expelled out of the piston chamber, passing in turn through the piston chamber channel 13p′, said groove, an outlet channel 13o′, out of the outlet port 10o′ when the piston housing 1′ is actuated to move along the piston 2′ to the round-shaped part 6a of the fluid pumping device (piston outstroke). This pump is of course adapted to work reversibly. Thus, the inlet and outlet ports of the above-described embodiment become respectively the outlet and inlet ports when the driving of the pump is offset by 180°.

### Second Embodiment of the Invention

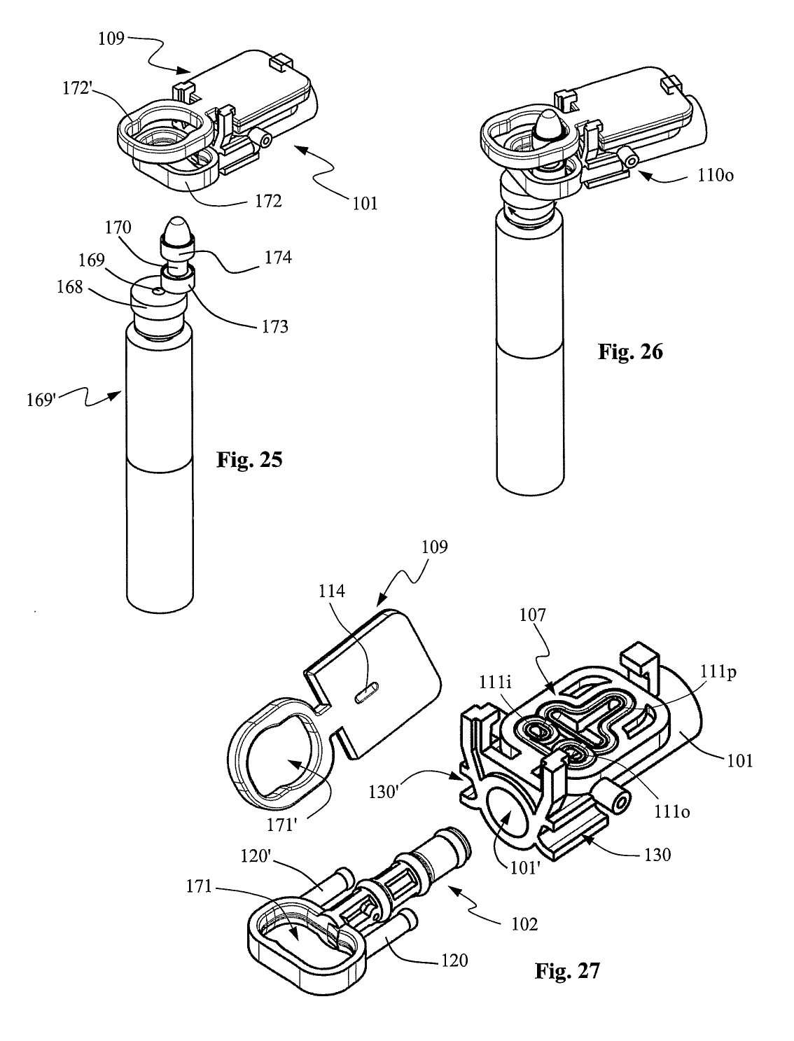

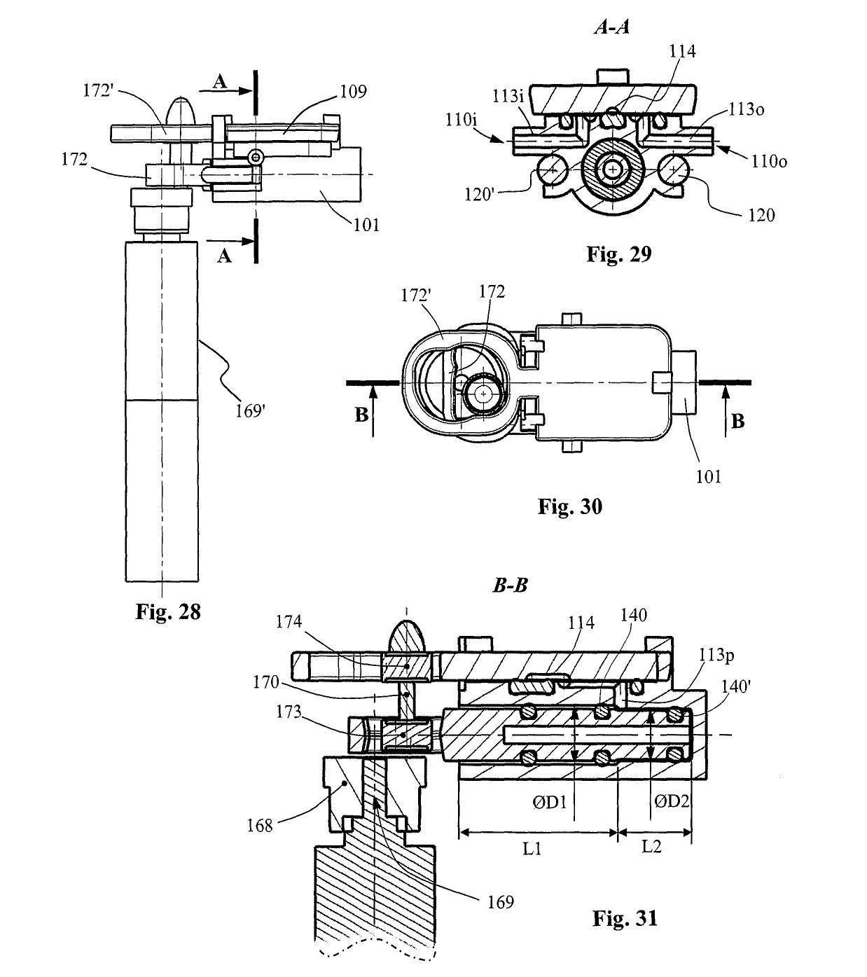

FIGS. 25 to 31 show a fluid delivery system according to a second embodiment of the invention. This fluid delivery system is advantageously designed to dispense with the guiding elements of the drive system as described in the first embodiment of the invention particularly in order to minimize its size and to simplify its manufacturing process.

For this purpose, the fluid pumping device comprises a lower and an upper part. The lower part as shown in FIG. 27 comprises a hollow cylindrical housing 101 (piston chamber) inside which a piston 102 is mounted so as to be movable back and forth inside said chamber, and an upper surface adapted to receive seal elements in the form of a gasket 107 which can be seen as representing the valve base member. Two cylindrical protruding parts 120, 120′ arranged on both lateral sides of the piston 102 are slidably mounted along two half-cylindrical guidance means 130, 130′ located on both lateral sides of the housing 101 so that piston 102 can be actuable by to-and-fro linear movements in a single plane. Gasket 107 is shaped as to define annular-rectangular-shaped (or 0-shaped) inlet and outlet cavities 111i, 111o that are connected to an inlet and an outlet port 110i, 110o by an inlet and an outlet channel 113i, 113o (FIG. 29), and a generally T-shaped piston chamber cavity 111p connected to the piston chamber by a piston chamber channel 113p (FIG. 31). The inlet and outlet cavities 111i, 111o are arranged next to each other along their common longitudinal axis that is oriented in a direction perpendicular to the piston movement, while the chamber cavity 111p is arranged to have a rectilinear part thereof adjacent to one lateral side of inlet and outlet cavities 111i, 111o.

Referring to FIG. 31, the piston chamber of the fluid pumping device has a first and a second axial extension L1, L2 having two different diameters D1, D2. A first and a second O-ring 140, 140′ are arranged around the piston 102 to move respectively along the first and the second axial extension L1, L2, during a pumping cycle. The piston chamber volume is therefore given by “((D1-D2)/2)²×π×L” where L is the length of the piston stroke, and is thus much smaller than the piston chamber volume given by the entire diameter of the piston chamber of the fluid delivery system as described in the first embodiment of the invention. A smaller bolus can therefore be delivered increasing the accuracy of the fluid delivery system.

As shown in FIG. 27, the upper part 109 (referred to hereafter as the valve-switching element) of the fluid pumping device comprises a flat bottom surface that has a rectilinear groove 114. Said flat bottom surface is mounted to come to contact with the gasket 107 of the lower part of the fluid pumping device. The valve-switching element 109 is actuable by to-and-fro linear movements in a direction perpendicular to the piston movement so that one part of the groove 114 extends partially above the piston chamber cavity 111p, while the other part of said groove 114 partially extends in turn above the 0-shaped inlet and outlet cavities 111i, 111o, as it moves back and forth perpendicularly along the longitudinal axis of said 0-shaped inlet and outlet cavities.

FIG. 25 shows a drive system adapted to impart to-and-fro linear movements to the piston 102 and to the valve-switching element 109. This drive system comprises a rotatable element 168 mounted around a rotary shaft 169 of a motor 169′. A second shaft 170 is eccentrically mounted on the rotatable element 168 to extend vertically therefrom and is adapted to protrude through two substantially rectangular-shaped apertures 171, 171′ of two superposed guiding elements 172, 172′ that form a part of respective piston 102 and valve-switching element 109 of the fluid pumping device. The two longitudinal axes of the two rectangular-shaped apertures 171, 171′ are perpendicular to each other so that rotation of the second shaft 170 actuates guiding element 172 to produce piston instrokes and oustrokes, and guiding element 172′ to move the valve-switching element 109 in a direction perpendicular to the piston movement.

More specifically, a first ball bearing assembly 173 is fitted around the second shaft 170 in order to rest against a part of the contour of aperture 171 of the piston guiding element 172, while a second ball bearing assembly 174 is fitted around said shaft 170 in order to rest against a part of the contour of aperture 171′ of the valve-switching guiding element 172′. Rotation of eccentric shaft 172 imparts to-and-fro linear movement to the piston 102 as the ball bearing 173 moves along the entire contour of aperture 171 of the piston guiding element 172, and a perpendicular to-and-fro linear movement to the valve-switching element 109 of the fluid pumping device, as the ball bearing 174 moves along the entire contour of aperture 171′ of the valve-switching guiding element 172′.

In operation of the above-described embodiment, the piston chamber is connected to the inlet port 110i of the fluid pumping device as the rectilinear groove 114 of the valve-switching element 109 moves along a part of the gasket 107 that is adjacent to both the inlet cavity 111i and the piston chamber cavity 111p during a piston instroke, thereby creating a first communication allowing leakage between said cavities 111i, 111p so that fluid is sucked from inlet port 110i passing in turn through inlet channel 113i, inlet cavity 111i, rectilinear groove 114, piston chamber cavity 111p and piston chamber channel 113p to fill the piston chamber. During a piston outstroke, the piston chamber is connected to the outlet port 110o of the fluid pumping device, as rectilinear groove 114 of the valve-switching element 109 moves further along a part of the gasket 107 that is adjacent to both the outlet cavity 111o and the piston chamber cavity 111p, thereby creating a second communication allowing leakage between said cavities 111o, 111p so that the fluid is expelled from the piston chamber, passing in turn through piston chamber channel 113p, piston chamber cavity 111p, rectilinear groove 114, outlet cavity 111o and outlet channel 113o out of the outlet port 110o.

The lower part of the fluid pumping device can be obtainable by an injection moulding process which comprises the following steps: (a) injecting a mouldable plastic material capable of forming a substantially rigid element into a mould cavity assembly for obtaining the base of said lower part; (b) placing a seal mould matrix on the upper part of said base where the base member is to be mounted, the seal mould matrix being designed to reproduce the shape of gasket 107; and (c) injecting into said matrix a mouldable rubber-elastic material in a flowable state, the rubber-elastic material polymerizing in the mould matrix while being bonded to the upper part of said base.

Gasket 107 can also be obtainable by a separate injecting moulding process and added on a corresponding groove arranged on the upper surface of the lower part of the fluid pumping device.

### Third Embodiment of the Invention

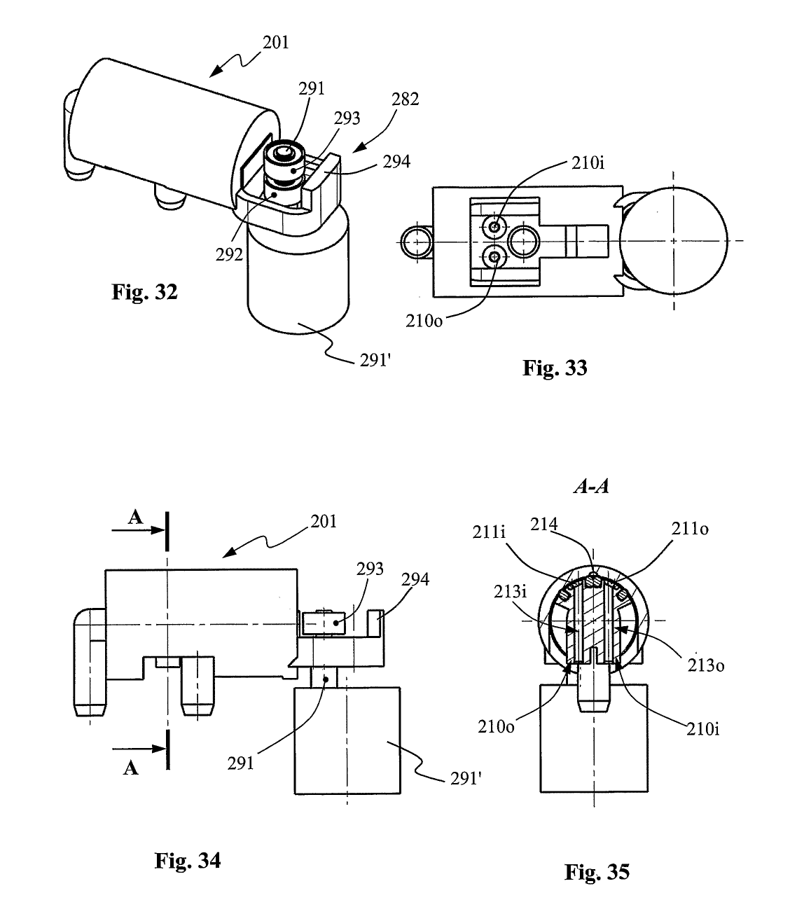

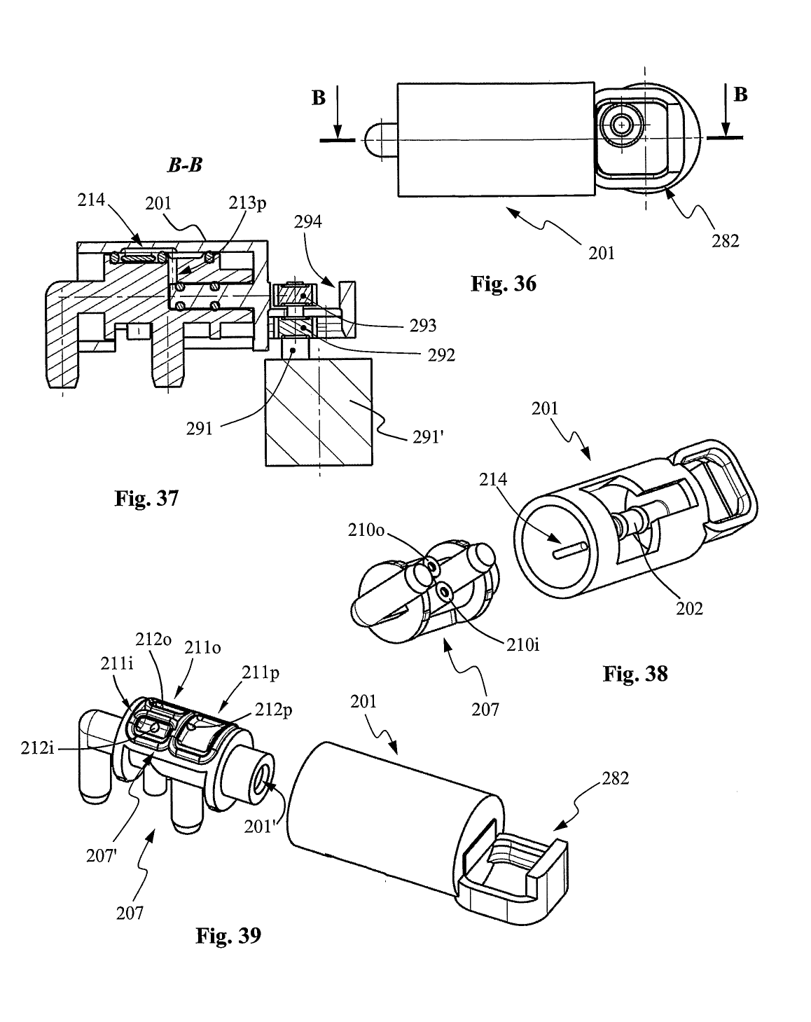

FIGS. 32 to 39 show a fluid delivery system according to a third embodiment of the invention. This system comprises a hollow cylindrical housing 201 that is adapted to receive a valve holder 207 (FIGS. 38 and 39) and to be actuable by to-and-fro linear and angular movements. A piston 202 is axially mounted inside the hollow cylindrical housing 201 to project inside a corresponding hollow cylindrical chamber 201′ of the valve holder 207. As shown by FIG. 39, a gasket 207′ is arranged on the outer surface of a cylindrical part of the valve holder 207 and is configured to define 0-shaped inlet and outlet cavities 211i, 211o and a rectangular piston chamber cavity 211p. Inlet and outlet cavities 211i, 211o are aligned adjacent to each other and to the piston chamber cavity 211p. Said inlet and outlet cavities 211i, 211o comprises respectively an inlet and an outlet aperture 212i, 212o that are connected to the inlet and outlet ports 210i, 210o of the fluid delivery system by respective inlet and outlet channels 213i, 213o (FIG. 35), while the piston chamber cavity 211p is connected to the piston chamber by a piston chamber channel 213p (FIG. 37). A rectilinear groove 214 is arranged on the inner surface of the pump housing 201 (FIG. 38) such that one part of said groove 214 extends above the piston chamber cavity 211p, while the other part of said groove 214 extends alternately above the inlet and outlet cavities 211i, 211o, as the cylindrical housing 201 rotates back and forth about its rotating axis.

To-and-fro linear and angular movements of the cylindrical housing 201 are imparted by a drive system that comprises a shaft 291 mounted eccentrically on a motor 291′ and around which a first and a second ball bearing 292, 293 are fitted (FIG. 37). This eccentric shaft 291 is arranged to extend through a substantially square aperture of a guiding element 282 connected to the pump housing 201. This guiding element 282 is mounted to be axially unbalanced with the piston axis such that during a pumping cycle the first ball bearing 292 swings the housing 201 around its rotating axis, while the second ball bearing 293 imparts to-and-fro linear movements to said housing 201 to produce piston instrokes and outstrokes.

Different sequences of the fluid delivery system of FIGS. 32 to 39, as it goes through a pumping cycle will now be described in more details.

The first ball bearing 292 of the eccentric shaft 291 moves along a first part of the inner contour of the guiding element 282 as said shaft 291 rotates through 90 degrees (FIG. 32), thereby rotating the cylindrical housing 201 such that its rectilinear groove 214 extends across a part of the gasket 207′ that is adjacent to the inlet cavity 211 i and the piston chamber cavity 211 p creating a first communication allowing leakage between said cavities 211i, 211p. The second ball bearing 293 is then brought into contact with a projecting part 294 of the guiding element 282 as the eccentric shaft 291 further rotates. A piston instroke is then produced as the second ball bearing 293 pushes against the guiding element projecting part 294, so that fluid can be sucked from the inlet port 210i of the fluid delivery system, passing in turn through inlet channel 213i (FIG. 35), inlet cavity 211i, rectilinear groove 214, piston chamber cavity 211p and piston chamber channel 213p to fill the piston chamber. As the piston 202 reaches the end of its instroke, the first ball bearing 292 moves along a second part of the inner contour of the guiding element 282 which is diametrically opposed to the first part, thereby rotating the pump housing 201 in an opposite direction such that its rectilinear groove 214 extends across a part of the gasket 207′ that is adjacent to the outlet cavity 2110 and the piston chamber cavity 211 p of the fluid delivery system creating a second communication allowing leakage between said cavities 211o, 211p. The second ball bearing 293 is then brought into contact with the lateral side of the cylindrical housing 201 as the eccentric shaft 291 further rotates. A piston outstroke is then produced as the second ball bearing 293 pushes against the lateral side of the housing 201 so that fluid can be released from the piston chamber, passing in turn through piston chamber channel 213p, piston chamber cavity 211p, rectilinear groove 214, outlet cavity 211o, and outlet channel 213o to be expelled out of the outlet port 210o of the fluid delivery system.

According to a variant, the above described second and third embodiments can be adapted to comprise a second piston chamber. For this purpose, a second fluid pumping device, identical to the one of the second or third embodiment of the invention, is coupled to its corresponding first fluid pumping device and is arranged symmetrically with respect to a median plane. In this configuration, first and second pistons and the valve system are guided by one or two common guiding elements such as described in the second or third embodiment such that a specific amount of fluid is sucked into the first piston chamber during first piston instrokes, while the same amount of fluid is expelled out of the second piston chamber during second piston outstrokes.

### Fourth Embodiment of the Invention

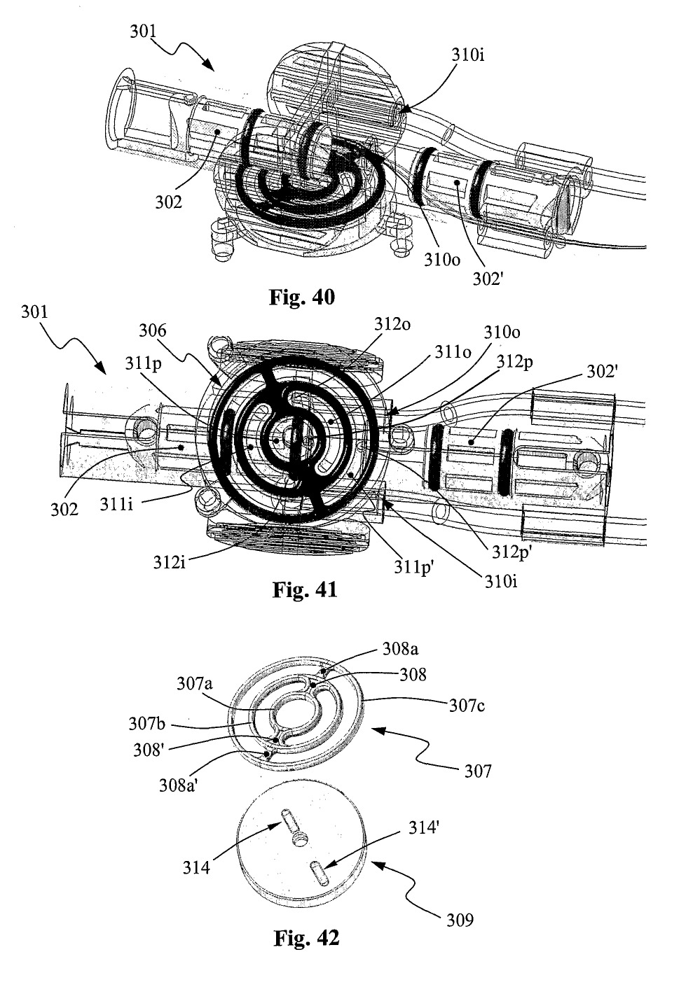

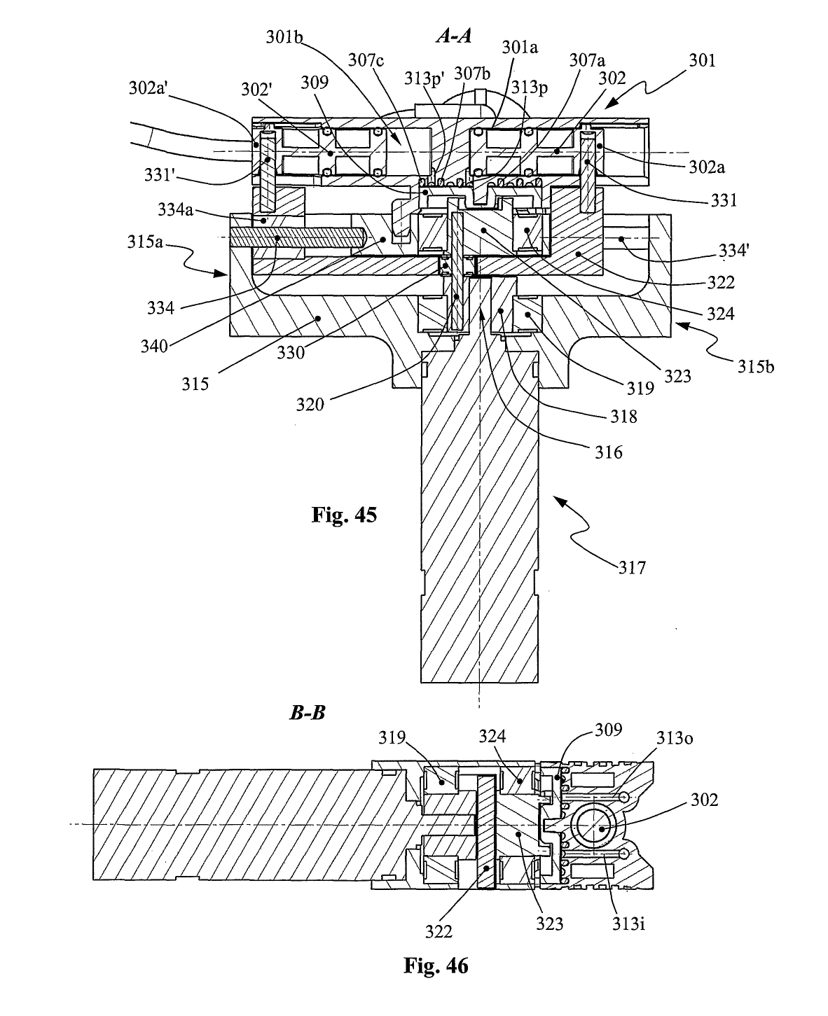

According to a fourth embodiment of the invention as shown in FIGS. 40 to 47, the fluid delivery system is designed for delivering a virtually continuous flow of a fluid. This fluid delivery system comprises a preferably disposable fluid pumping device that comprises a cylindrical housing 301 containing a first and a second chamber 301a, 301b arranged opposite to each other along the longitudinal axis of the housing 301 (FIGS. 40 and 45). A first and a second piston 302, 302′ are mounted so as to be movable back and forth inside said first and second piston chamber.

As shown in FIG. 41, the bottom part of the fluid pumping device comprises a cylindrical recess 306 that has a substantially flat bottom surface against which a seal element in the form of a gasket 307 (FIG. 42) is bonded to. Said gasket 307 comprises three concentric rings, namely inner, middle and outer rings 307a, 307b, 307c. Inner and middle rings 307a, 307b are connected together by a first and a second sealing part 308, 308′ that are diametrically opposed. Gasket 307 further comprises two attaching means 308a, 308a′ to hold the outer ring 307c with the middle ring 307b. A valve-switching element 309, in the form of a disc, is rotatably mounted on gasket 307, which can be seen as representing the valve base member.

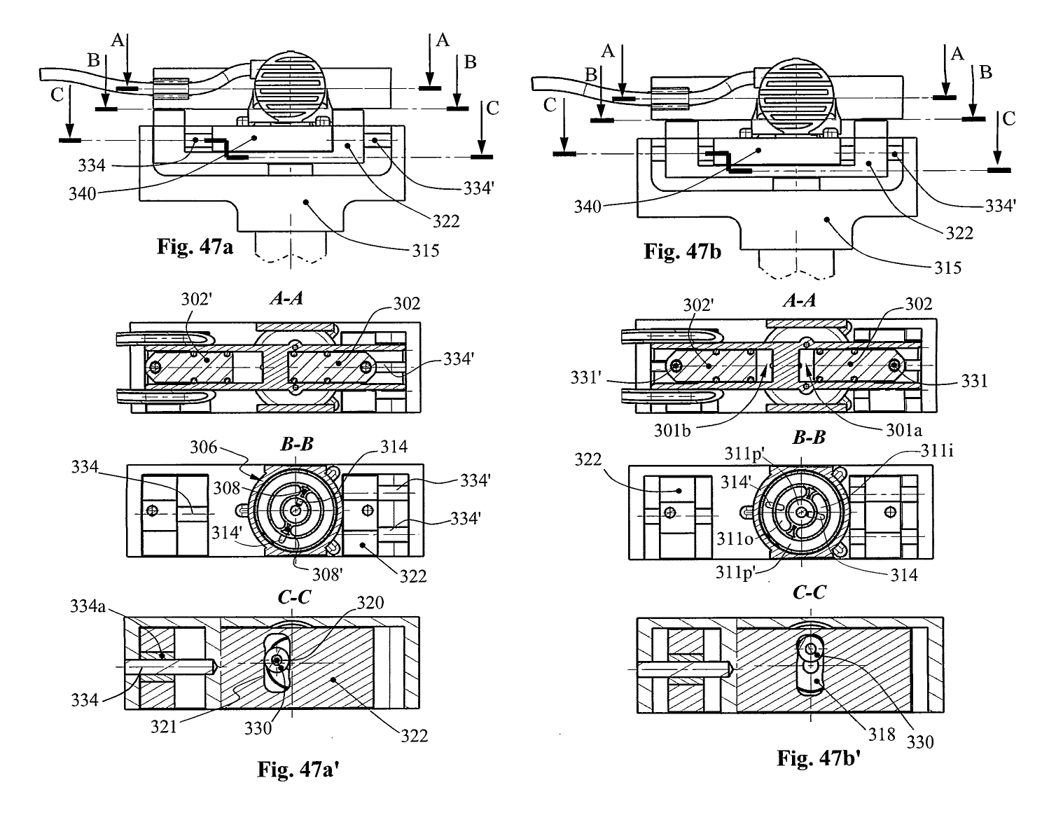

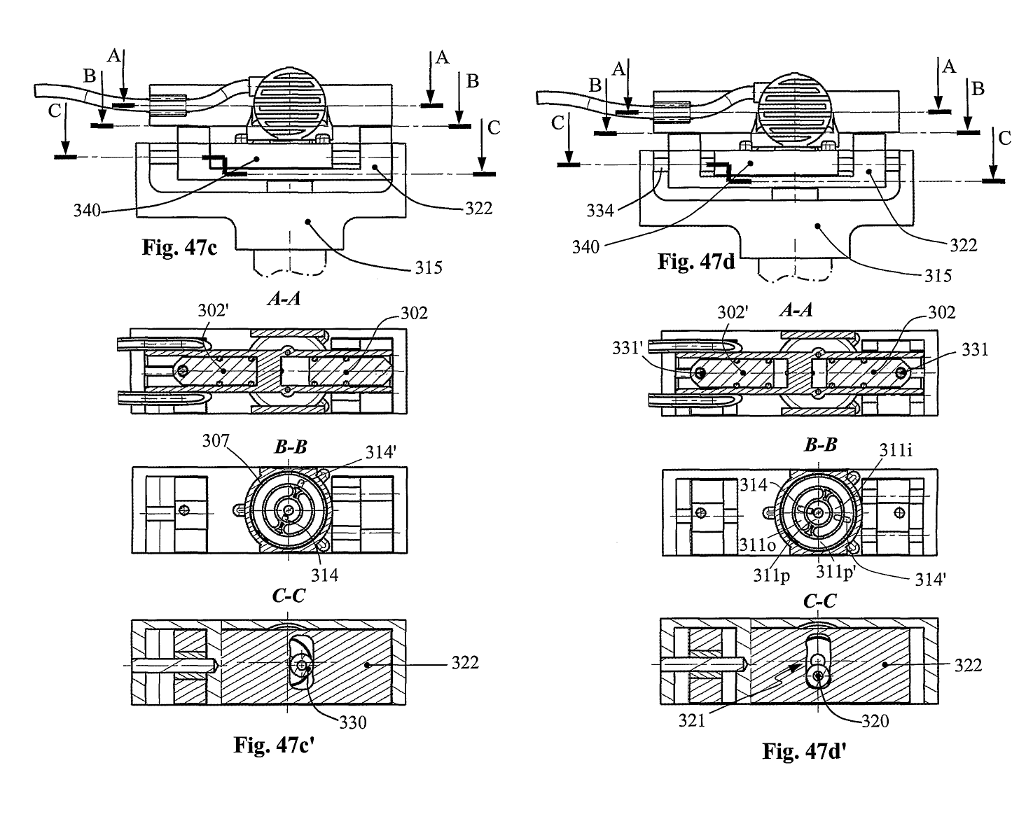

As shown for example in cross-sectional view B-B of FIG. 47b, inner ring 307a defines a first piston chamber cavity 311p while arcuate inlet and outlet cavities 311i, 311o, that are symmetrically opposed with respect to the rotation axis of disc 309, are defined by inner and middle rings 307a, 307b and the two sealing parts 308, 308′. An annular second piston chamber cavity 311p′ is further defined by middle and outer rings 307b, 307c.

With reference to FIG. 41, the cylindrical recess 306 comprises on its bottom surface inlet and outlet apertures 312i, 312o which are located inside respectively inlet and outlet cavities 311i, 311o, and first and second piston chamber apertures 312p, 312p′ which are located inside respectively the first and second piston chamber cavities 311p, 311p′. Inlet and outlet apertures 312i, 312o are in fluid communication respectively with an inlet port 310o by means of an inlet channel 313i and with an outlet port 310o by means of an outlet channel 313o (FIG. 46), while the first and second piston chamber apertures 312p, 312p′ are in fluid communication with the first and second piston chambers 301a, 301b by means of first and second piston chamber channels 313p, 313p′ (FIG. 45).

With reference to FIG. 42, the disc 309 comprises a first and a second identical rectilinear groove 314, 314′ extending along two segments of its diameter. The first rectilinear groove 314 stands near the rotation axis of the disc 309 and is arranged to extend radially to both sides of the gasket inner ring 307a, while the second rectilinear groove 314′ stands near the periphery of the disc 309 and is arranged to extend radially to both sides of the gasket middle ring 307b, when disc 309 is rotatably mounted against said gasket 307.

As shown in FIG. 45, the drive system of the fluid pumping device according to this embodiment comprises a U-shaped supporting structure 315 having a lower part adapted to receive a rotary shaft 316 of a motor 317. A first rotatable element 318 is coaxially mounted on said shaft 316 and is laterally secured by a first ball bearing assembly 319. The lower part of a second shaft 320 is fixedly mounted eccentrically on the rotatable element 318 and extends vertically therefrom through a rectangular-shaped aperture 321 of a U-shaped sliding tray 322 (cross-sectional view C-C of FIG. 47a) to have its upper part connected eccentrically to a second rotatable element 323 (FIG. 45), wherein the second rotatable element 323 is axially aligned with the first rotatable element 318 and laterally secured by a second ball bearing assembly 324 mounted on a supporting piece 340 to which the housing 301 of the fluid pumping device is fixed.

The disc 309 is fixed on the second rotatable element 323 and is thus continuously rotating at controlled speed through an angle of 360° during a pumping cycle. The first and second rectilinear grooves 314, 314′ are therefore arranged to move perpendicularly along the entire circumference of respective gasket inner ring and middle ring 307a, 307b during a pumping cycle.

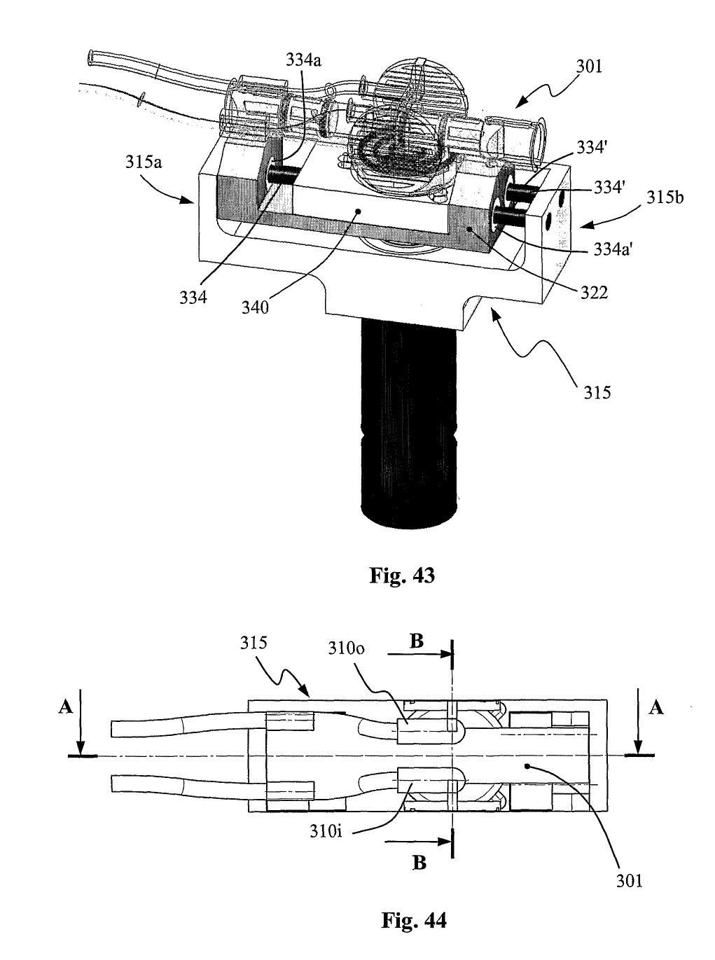

The U-shaped sliding tray 322 is mounted to be actuable by to-and-fro linear movements across the U-shaped supporting structure 315. To this end, as shown in FIG. 43, one rod 334 is arranged to protrude perpendicularly from one lateral side 315a of the supporting structure 315 to extend through a corresponding linear bearing 334a located in one side of the tray 322 to be fixedly secured to one lateral side of the supporting piece 340, while a pair of rods 334′ are mounted parallel to each other and protrude perpendicularly from the other lateral side 315b of the supporting structure 315 to extend through two corresponding linear bearings 334a′ located in the other side of the sliding tray 322 to be fixedly secured to another lateral side of the supporting piece 340.

To-and-fro linear movements of the sliding tray 322 is imparted by a ball-bearing assembly 330 which is fitted around the eccentric shaft 320 inside the rectangular-shaped aperture 321 of the tray 322 (cross-sectional view C-C of FIG. 47a). A first and a second piston driving shaft 331, 331′ are arranged to protrude vertically from the sliding tray 322 near each of its lateral sides and extend through the heads 302a, 302a′ of the first and second pistons 302, 302′ in order to impart to-and-fro linear movements to said pistons inside their respective chambers 301a, 301b (FIG. 45).

Detailed description of the fluid delivery system according to this fourth embodiment of the invention as it goes through the principal phases of a pumping cycle will now be described particularly with reference to FIGS. 47a to 47d.

FIG. 47a and its corresponding cross-sectional views (FIG. 47a′) show the fluid delivery system just before the beginning of a pumping cycle when there is substantially no movement of the first and second pistons 302, 302′ and when the switching of the valves occurs. At this stage of the pumping cycle, the sliding tray 322 has been pushed by the ball bearing assembly 330 to one of its farthest lateral positions (cross-sectional view C-C of FIG. 47a) and each of the two rectilinear grooves 314, 314′ of disc 309 are angularly positioned to extend radially under each of the two sealing parts 308, 308′ of the gasket 307 (cross-sectional view B-B of FIG. 47a). In this configuration, the first and second piston chambers are entirely sealed from the inlet and outlet ports 310i, 310o of the fluid delivery system while disc 309 rotates to bring its first and second rectilinear grooves 314, 314′ from one side to the other side of each of the two sealing parts 308, 308′ of said gasket 307, whereupon first rectilinear groove 314 creates a leakage between the first piston chamber cavity 311p and the arcuate inlet cavity 311i, while second rectilinear groove 314′ creates a leakage between the second piston chamber cavity 311p′ and the arcuate outlet cavity 311o. As a result, first piston chamber 301 is in constant fluid communication with the inlet port 310i of the fluid delivery system, while the second piston chamber 301′ is in constant fluid communication with the inlet port 310i of said system.

From this instant, the ball bearing assembly 330, which rotates eccentrically, is in contact with the border of rectangular aperture 321 and pushes forwards sliding tray 322 producing an instroke of the first piston 302 and an outstroke of the second piston 302′ (cross-sectional view A-A of FIG. 47b), by means of the first and the second piston driving shaft 331, 331′. During this pumping phase, the disc 309 rotates through an angle of approximately 150°, thereby moving its first rectilinear groove 314 along a part of the gasket inner ring 307a that is adjacent to both arcuate inlet cavity 311i and first piston chamber cavity 311p and its second rectilinear groove 314′ along a part of the gasket middle ring 307b that is adjacent to both second piston chamber cavity 311p′ and arcuate outlet cavity 3110 (cross-sectional view 8-8 of FIG. 47b). A predefined amount of fluid is therefore sucked from the inlet port 310i, passing in turn through inlet channel 313i, arcuate inlet cavity 311i, first rectilinear groove 314, first piston chamber cavity 311p and first piston chamber channel 313p to fill the first piston chamber 301a during an instroke of the first piston 302, while a same amount of fluid is expelled from the second piston chamber 301b, passing in turn through second piston chamber channel 313p′, second piston chamber cavity 311p′, second rectilinear groove 314′, arcuate outlet cavity 311o, outlet channel 313o to the outlet port 310o during an outstroke of the second piston 302′.

FIG. 43c and its corresponding cross-sectional views (FIG. 47c′) show the fluid delivery system at the end of the instroke and the outstroke of respective first and second pistons 302, 302′ when switching of the valves occurs.

At this stage of the pumping cycle, the sliding tray 322 has been pushed by the ball bearing assembly 330 to the other of its farthest lateral positions (cross-sectional view C-C of FIG. 47c) and each of the two rectilinear grooves 314, 314′ of the disc 309 are angularly positioned to extend radially under each of the two sealing parts 308, 308′ of gasket 307 (cross-sectional view B-B of FIG. 47c). In this configuration, the first and second piston chambers 301a, 301b are entirely sealed from the inlet and outlet ports 310i, 310o of the fluid delivery system, while disc 309 rotates to bring its first and second rectilinear grooves 314, 314′ from one side to the other side of each of the two sealing parts 308, 308′ of said gasket 307, whereupon first rectilinear groove 314 creates a leakage between the first piston chamber cavity 311p and the arcuate outlet cavity 311o, while second rectilinear groove 314′ creates a leakage between the second piston chamber cavity 311p′ and the arcuate inlet cavity 311i. As a result, the first piston chamber 301 a is in constant fluid communication with the outlet port 310o of the fluid delivery system, while the second piston chamber 301′ is in constant fluid communication with the inlet port 310o of said system.

From this instant, the ball bearing assembly 330, which rotates eccentrically, is in contact with the border of rectangular-shaped aperture 321 and pushes forwards the sliding tray 322 (cross-sectional view C-C of FIG. 47d) producing an outstroke of the first piston 302 and an instroke of the second piston 302′ by means of the first and second piston driving shafts 331, 331′ (cross-sectional view A-A of FIG. 47d). During this pumping phase, the disc 309 further rotates through an angle of approximately 150°, thereby moving its first rectilinear groove 314 along a part of the gasket inner ring 307a that is adjacent to both arcuate outlet cavity 311o and first piston chamber cavity 311p, and its second rectilinear groove 314′ along a part of the gasket middle ring 307b that is adjacent to both second piston chamber cavity 311p′ and arcuate inlet cavity 311i (cross-sectional view B-B of FIG. 47d). Fluid is therefore expelled from the first piston chamber 301a of the fluid delivery system, passing in turn through first piston chamber channel 313p, first piston chamber cavity 311p, first rectilinear groove 314, arcuate outlet cavity 311o, outlet channel 313o to the outlet port 310o, during an outstroke of the first piston 302, while a same amount of fluid is sucked from the inlet port 310i of the fluid delivery system, passing in turn through inlet channel 313i, arcuate inlet cavity 311i, second rectilinear groove 314′, second piston chamber cavity 311p′ and second piston chamber channel 313p′ to fill the second piston chamber 301b during an instroke of the second piston 302′. The fluid delivery system according to this fourth embodiment of the invention can therefore deliver a virtually continuous flow of a fluid.

### Fifth Embodiment of the Invention

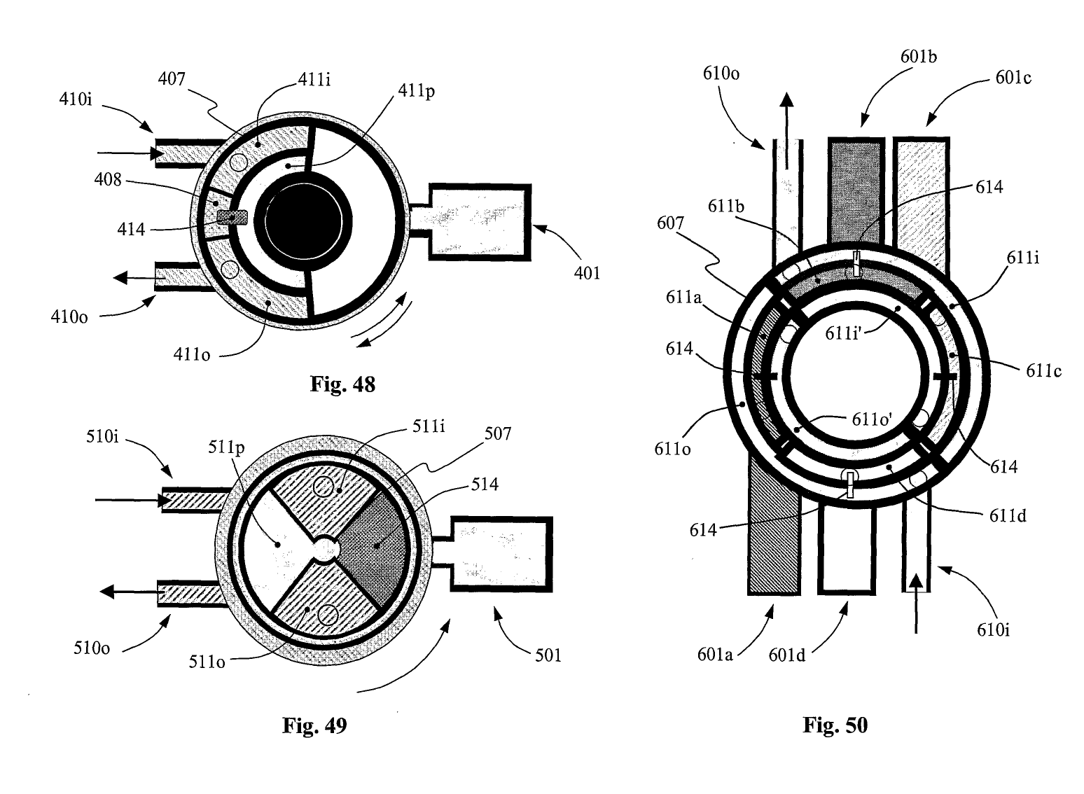

According to a fifth embodiment of the invention, the fluid delivery system comprises a valve system as schematically shown in FIG. 48. This valve system has a disc (not shown) that comprises a rectilinear groove 414. The disc is rotatably mounted on a gasket 407 to be actuable by a bi-directional angular movement through an angle of 180°. Gasket 407 is fashioned as to define an inner half-ring-shaped cavity 411p connected to a piston chamber 401 and an outer half-ring-shaped part that is adjacent to said inner half-shaped cavity 411p and that is divided in two identical arcuate inlet and outlet cavities 411i, 411o by a sealing part 408. Said cavities 411i, 411o are connected respectively to an inlet and an outlet port 410i, 410o of the fluid delivery system. Rectilinear groove 414 is arranged on the rotatable disc such that during piston instrokes it moves along and extends radially across a part of gasket 407 that is adjacent to the arcuate inlet cavity 411i and the half-ring-shaped cavity 411p, thereby creating a first communication allowing leakage between said cavities 411i, 411p so that fluid is sucked through the inlet port 410i into the piston chamber 401 during a piston instroke, while rectilinear groove 414 moves along and extends radially across a part of gasket 407 that is adjacent to the arcuate outlet cavity 411o and the half-ring-shaped cavity 411p, thereby creating a second communication allowing leakage between said cavities 411o, 411p so that fluid is expelled out of the piston chamber 401, through the outlet port 410o during a piston outstroke.

### Sixth Embodiment of the Invention

According to a sixth embodiment of the invention, the fluid delivery system comprises a valve system as schematically shown in FIG. 49. This valve system comprises a disc (not shown) that has an angular-sector-shaped recess 514. The disc is rotatably mounted on a gasket 507 to be actuable by a one-way angular movement. Gasket 507 is shaped as to define two identical angular sector-shaped cavities 511i, 511o diametrically opposed (said cavities being referred to hereafter as the inlet and the outlet cavity), and which are connected respectively to an inlet and an outlet port 510i, 510o of the fluid delivery system, while two other diametrically opposed cavities 511p (one of them is hidden by the recess 514) are connected to the piston chamber 501 (said cavities being referred to hereafter as the two piston chamber cavities). Recess 514 is arranged on the rotatable disc such that during piston instrokes it moves across a part of gasket 507 that is adjacent to the inlet cavity 511i, and one of the two piston chamber cavities 511p, thereby creating a first communication allowing leakage between said cavities so that fluid is sucked into the piston chamber 501 during a piston instroke, while during piston outstrokes, recess 514 moves across a part of gasket 507 that is adjacent to the outlet cavity 511o, and the other of the two piston chamber cavities 511p, thereby creating a second communication allowing leakage between said cavities so that fluid is expelled out of the piston chamber 501 during a piston outstroke.

### Seventh Embodiment of the Invention

According to a seventh embodiment of the invention, the fluid delivery system comprises a valve system as schematically shown in FIG. 50. The valve system comprises a disc (not shown) that contains four rectilinear grooves 614 angularly offset from each others by substantially 90 degrees. The disc is rotatably mounted on a gasket 607 that is configured to define an outer ring-shaped part divided as to form first arcuate inlet and outlet cavities 611i, 611o connected respectively to an inlet and outlet port 610i, 610o of the fluid delivery system, a middle ring-shaped part divided in four arcuate piston chamber cavities 611a, 611b, 611c, 611d, that are each connected to a piston chamber 601a, 601b, 601c, 601d and an inner ring-shaped part divided as to form second arcuate inlet and outlet cavities 611i′, 611o′ connected respectively to the inlet and outlet ports 610i, 610o of the fluid delivery system.

### Eighth Embodiment of the Invention

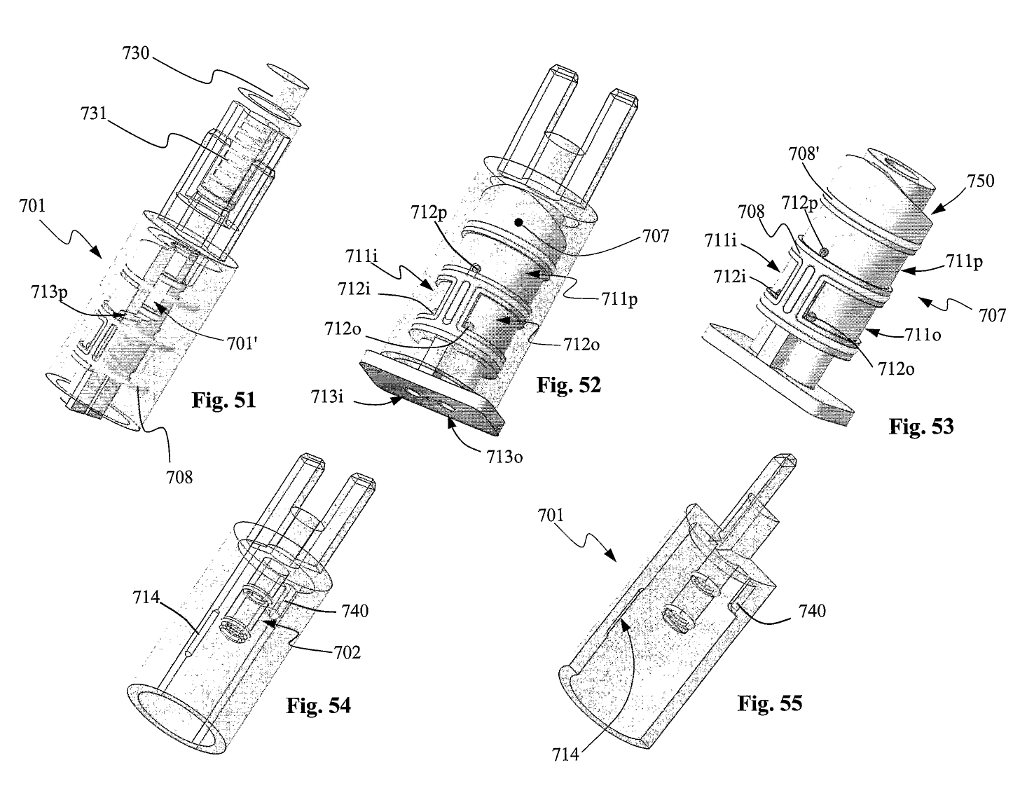

FIGS. 51 to 55 show a fluid pumping device having another valve configuration according to an eighth embodiment of the invention This fluid pumping device comprises a hollow cylindrical housing 701 that is designed to receive a cylindrical valve holder 707, which acts as the valve base member. A rotor 730 is adapted to impart an angular movement to the hollow cylindrical housing 701 while the cylindrical valve holder 707 remains static. A piston 702 is axially mounted inside the hollow cylindrical housing 701 of the fluid pumping device to project inside a corresponding cylindrical chamber 701′ of the valve holder 707.

As shown particularly in FIG. 53, a gasket 708 is arranged on the outer surface of the cylindrical valve holder 707 and is configured to define inlet and outlet cavities 711i, 711o which are opposite to each other with respect to the valve holder axis and extend preferably through 165° around said holder 707. An O-ring 708′ is arranged around the entire circumference of the cylindrical valve holder 707 so as to define an annular cavity 711p that is adjacent to a part of gasket 708, said annular cavity 711p being referred to hereafter as the piston chamber cavity. Valve holder 707 comprises inlet, outlet and piston chamber apertures 712i, 712o, 712p which are located inside respectively the inlet, outlet and piston chamber cavities 711i, 711o, and 711p.

Inlet and outlet cavities 711i, 711o are connected respectively to an inlet and an outlet port of the fluid pumping device by an inlet and an outlet channel 713i, 713o, while the piston chamber cavity 711p is connected to the piston chamber 701′ by a piston chamber channel 713p (FIG. 51).

A rectilinear groove 714 is arranged on the inner surface of the housing 701 (FIG. 55) such that one part of groove 714 extends partially above the piston chamber cavity 711p, while the other part of groove 714 partially extends alternately above the inlet and outlet cavities 711i, 711o, as the housing 701 rotates through 360° to complete a pumping cycle.

A helical surface 750 extends around the upper part of the cylindrical valve holder 707 on an inclined plane and is designed to be in contact with a guiding projecting part 740 located inside the housing 701 of the fluid pumping device (FIG. 55). A spring 731 is mounted at one end of the housing 701 (FIG. 51) whereby a to-and-fro linear movement is imparted to the latter as the guiding projecting part 740 moves along the entire circumference of the helical surface 750 when an angular movement is imparted to the pump housing 701 by the rotor 730. The spring 731 ensure that the guiding projecting part 740 is always in contact with the helical surface 750 to guarantee a right positioning of the hollow cylindrical housing 701 versus the cylindrical valve holder 702.

Different sequences of the fluid pumping device of FIGS. 51 to 55 as it goes through a pumping cycle will now be described. At the beginning of a pumping cycle, the rectilinear groove 714 is arranged to move along a part of the gasket 708 that is adjacent to both the inlet cavity 711i and the piston chamber cavity 711p as the pump housing 701 rotates, thereby creating a first communication allowing leakage between said cavities 711i, 711p, while the projecting part 740 of the housing 701 moves up a gradient of the helical surface 750, thereby creating a piston instroke of the fluid pumping device. During said piston instroke, fluid can be sucked from the inlet port, passing in turn through inlet channel 713i, inlet cavity 711i, rectilinear groove 714, piston chamber cavity 711p and piston chamber channel 713p to fill the piston chamber 701′.

At the end of the piston instroke, the projecting part 740 of the pump housing 701 moves along a part of the helical surface 750 which has no gradient to ensure no movement of the piston 702 when the switching of the valves occurs. The rectilinear groove 714 then moves along a part of the gasket 708 that is adjacent to both the outlet cavity 711o and the piston chamber cavity 711p as the pump housing 701 further rotates, thereby creating a second communication allowing leakage between said cavities 711o, 711p, while the projecting part 740 of housing 701 moves down a gradient of the helical surface 750, thereby creating a piston outstroke of the fluid pimping device. During said piston outstroke, fluid can be released from the piston chamber 701′, passing in turn through piston chamber channel 713p, piston chamber cavity 711p, rectilinear groove 714, outlet cavity 711o, and outlet channel 713o to be expelled out of the outlet port of the fluid pumping device.

It has to be noted that the rectilinear groove 714 is shaped so as to be long enough to ensure that it moves continuously above both the piston chamber cavity 711p and the inlet and outlet cavities 711i, 711o during a pumping cycle. In a variant, one would consider adapting the fluid pumping device in order to have the part adjacent to the piston chamber cavity and the inlet and outlet cavities configured such that it follows the to-and-fro linear angular movements of the rectilinear groove 714 during a pumping cycle.

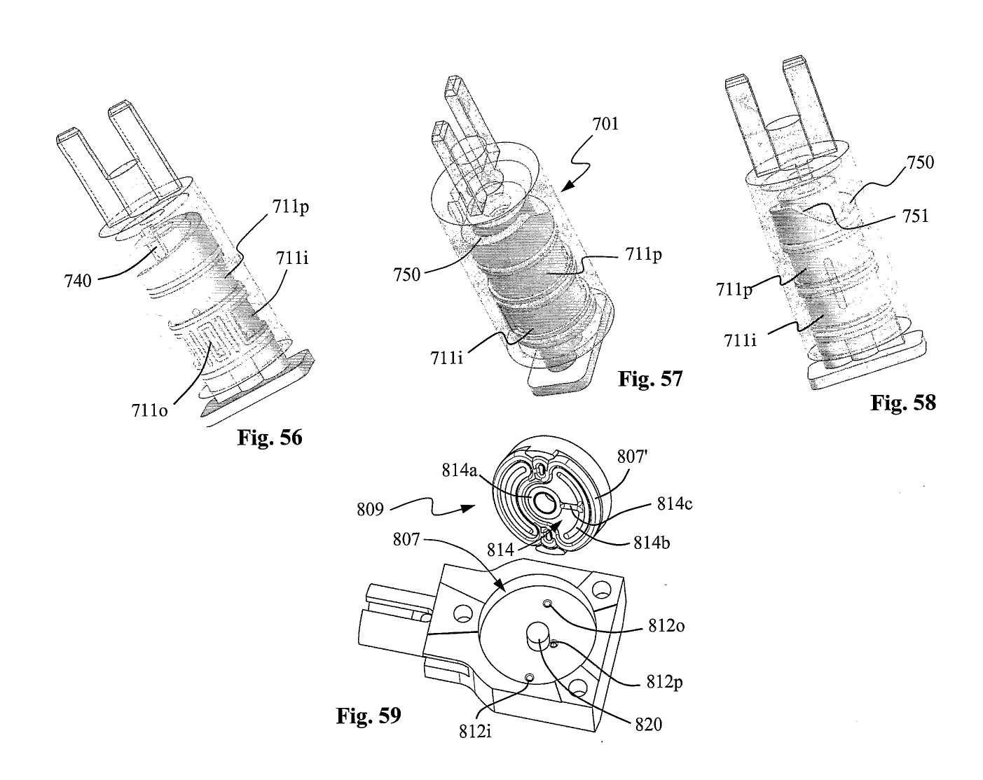

Besides, as shown by FIGS. 56 to 58, the fluid pumping device can be modified to adapt the linear speed imparted to the piston 702 during its instroke to the type of fluid that needs to be pumped. In this configuration, the inlet cavity 711i extends around the cylindrical valve holder 707 through an angle which is preferably between 280° and 320°, while the outlet cavity 710o extends around said valve holder through an angle which is preferably between 10° to 60°. The helical surface 750 is adapted to have a positive gradient through an angle 280° and 320° and a negative gradient 751 through an angle between 10° to 60° so that a full piston oustrokes occurs when the guiding projecting part 740 moves along this negative gradient. The pump chamber can therefore be filled slowly to prevent any cavitation phenomena. This pump can be designed to be actuable clockwise and anticlockwise to be able to fill and empty the pump chamber slowly (through ˜280°) or rapidly (through ˜40°).

The size of the inlet and outlet cavities 711i, 711o as well as the profile of the helical surface can be adapted so that the filling of the piston chamber is performed by rotating the cylindrical housing 701 through an angle varying from 1 to 350 degrees.

The helical surface 750 of the cylindrical valve holder 707 or another part of the fluid pumping device can be toothed so that the cylindrical housing 701 can be maintained in an axial position effortlessly by mean of a pawl in order to be suitable to be driven manually.

### Ninth Embodiment of the Invention

According to a ninth embodiment of the invention, the fluid pumping device comprises a valve system wherein seal elements are part of the valve-switching element while the valve base member comprises inlet, outlet and piston chamber apertures, which are respectively connected to the inlet and outlet ports and the piston chamber of the fluid pumping device.

FIG. 59 shows a valve system of the fluid pumping device according to this particular embodiment, wherein a seal element 807′ is over-molded to a disc 809 which comprises in its center a circular opening so that said disc 809 is rotatably arranged around a shaft 820 axially mounted inside a cylindrical recess 807. The latter has a flat base that comprises an inlet, an outlet and a piston chamber aperture 812i, 812o, 812p. Inlet and outlet apertures 812i, 812o are preferably diametrically opposed and located close to the circumference of recess 807, while piston chamber aperture 812p is located next to the shaft 820 about which disc 809 is rotatably mounted. Seal element 807′ is shaped to define a groove 814 that has an annular part 814a arranged to come to contact with the cylindrical base around the circumference of the shaft 820, and an arcuate part 814b near the periphery of said disc 809. The arcuate part 814b of said groove is curved with respect to the rotation axis of disc 809 and extends through about 150°. Annular and arcuate part 814a, 814b of the groove 814 are in fluid communication with each other by means of a radial groove 814c.

In operation of the above-described embodiment, one extremity of arcuate groove 814b overlaps the inlet aperture 812i and creates a first communication allowing leakage between said inlet aperture 812i and the piston chamber aperture 812p at the beginning of a pumping cycle. Fluid is then sucked from the inlet port of the fluid pumping device, passing in turn through a part of arcuate groove 814b, radial groove 814c, a part of annular groove 814a, into the piston chamber as disc 809 rotates through about 150° during a piston instroke. At the end of the piston instroke, the inlet aperture 812i is sealed and one extremity of arcuate groove 814b overlaps the outlet aperture 812o as disc 809 further rotates creating a second communication allowing leakage between the piston chamber aperture 812p and the outlet aperture 812o. Fluid is then expelled from the piston chamber, passing in turn through a part of annular groove 814a, radial groove 814c, and a part of arcuate groove 814b, out of outlet port of the fluid pumping device as disc 809 further rotates through about 150° during a piston outstroke.

### Tenth Embodiment of the Invention

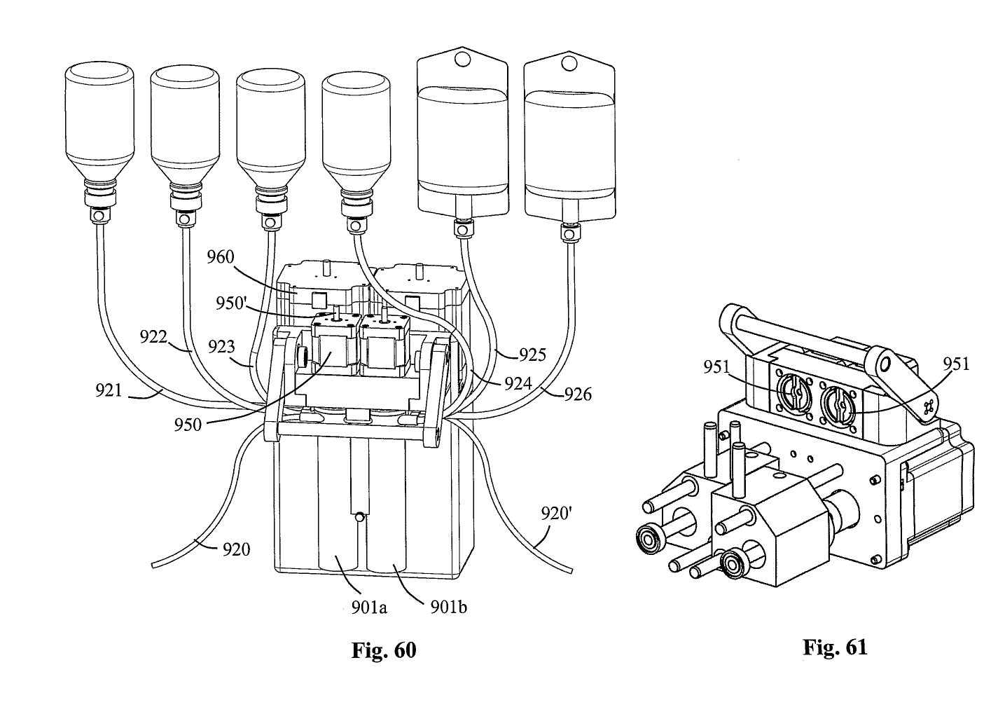

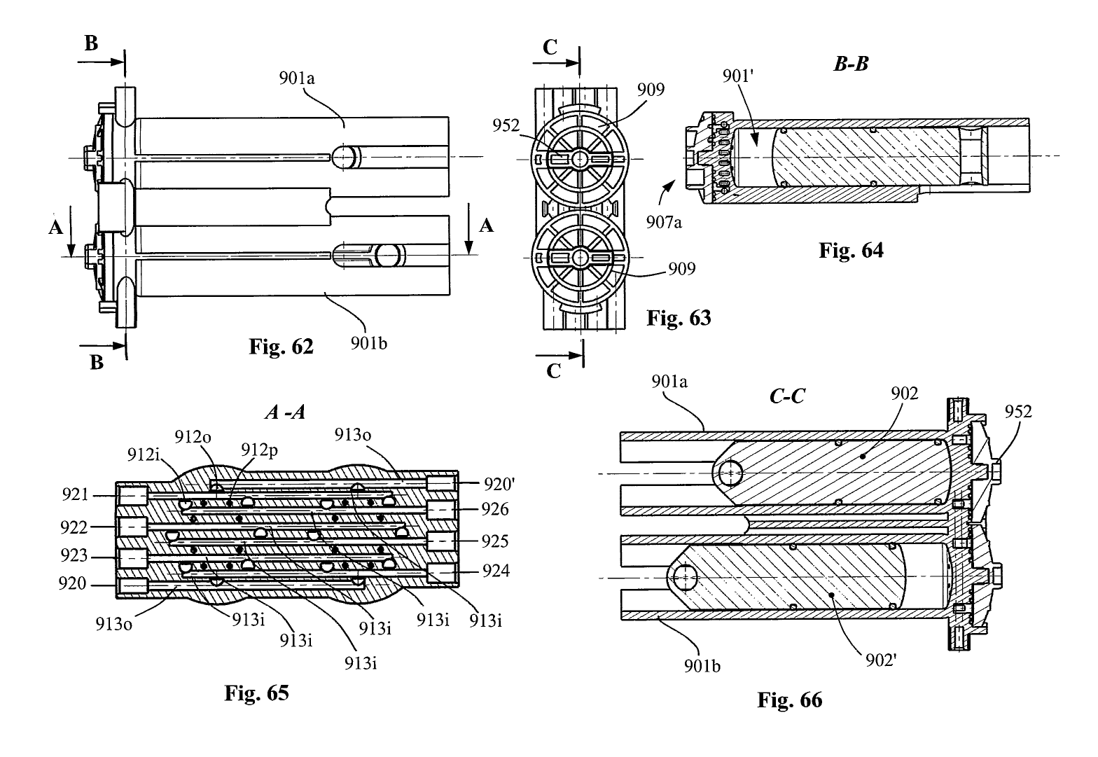

FIGS. 60 to 67 show a fluid delivery system designed for mixing different fluids according to a tenth embodiment of the invention. This system includes a fluid pumping device that comprises a first and a second piston 902, 902′ arranged to be actuable inside a first and a second piston housing 901a, 901b (FIG. 66) and a plurality of ports 921, 922, 923, 920, 920′, 926, 925 and 924 (FIG. 65), that are each capable of being in fluid communication with the first and second piston chambers 901′ during an instroke or an outstroke of said first and second pistons 902, 902′. The fluid delivery system is therefore adapted to be configured so as to have the desired inlet ports connected to different type of fluids. In this specific embodiment, the fluid delivery system is configured as to have six inlet ports 921, 922, 923, 924, 925, 926 connected to different type of fluids and two outlet ports 920, 920′ (FIG. 60).

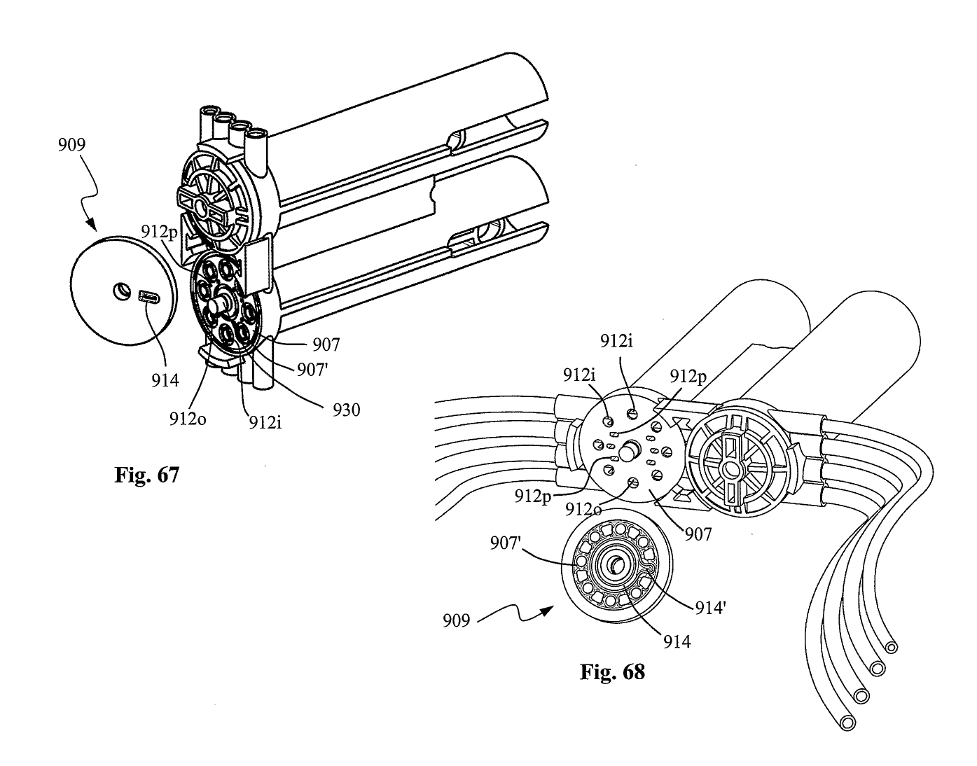

The inlet and outlet ports selection of the fluid delivery system is achieved by two valve systems 900a mounted at one end of each piston housing 901a, 901b opposite each piston chamber 901′ (FIG. 64). As shown in FIG. 67, each valve system comprises a valve-switching element in the form of a disc 909 which is rotatably mounted on a shaft 930 that protrudes from a circular substantially flat surface 907 along the piston axis. This circular surface 907, which is referred to hereafter as the valve-base member, comprises six inlet apertures 912i and two outlet apertures 912o that are arranged in a circular pattern near the periphery of said valve-base member 907. As shown in FIG. 65, each of the six inlet apertures 912i of each valve system are connected to their corresponding inlet port 921, 922, 923, 924, 925, 926 by means of a mutual inlet channel 913i, while each of the two outlet apertures 9120 of each valve system are connected to their corresponding outlet port 920, 920′ by means of a mutual outlet channel 913o. The valve base member 907 of each valve system further comprises eight piston chamber apertures 912p that are in fluid communication with the piston chamber (FIG. 65).

As shown in FIG. 67, a fluid seal element in the form of a O-ring 907′ is fitted over each of the inlet and outlet apertures 912i, 912o on the valve base member 907, while the surface of the disc 909, which comes to contact with the valve base member 907, comprises a rectilinear groove 914 arranged to overlap one of the eight inlet and outlet apertures 912i, 912o and a corresponding piston chamber aperture 912p.

As shown in FIG. 60, the two valve systems and the first and second pistons 902, 902′ are arranged to be driven by two independent drive systems 950, 960. A valve drive system 950 comprises a shaft 950′ that is arranged to impart a rotating movement to a valve driving disc 951 which has a rectilinear groove adapted to receive a corresponding bulge 952 extending across the entire diameter of the valve-switching element 909 (FIG. 63). The reciprocating movements of the two pistons 902, 902′ are preferably opposite to each other to ensure a virtually continuous flow delivery. Said pistons are preferably actuated by an endless-screw drive system or a hydraulic motor.

In operation of the above-described embodiment, the valve-switching element 909 is angularly actuable to move the rectilinear groove 914 above one of the six inlet apertures 912i so that the piston chamber 901′ is in fluid communication with the desired inlet port, whereupon a fluid can be sucked from said inlet port, through inlet channel 913i, inlet aperture 912i, groove 914, and the corresponding piston chamber aperture 912p into the piston chamber 901′ during a part of a piston instroke. The piston can be immobilized at any point during the course of its instroke for a period during which the valve-switching element 909 is angularly actuated by its drive system to move its groove 914 above another of the six inlet apertures 912i to connect the piston chamber 901′ with another inlet port, whereupon a different type of fluid can be sucked into the piston chamber during another part of a piston instroke. Switching of the valves can occur any time during a piston instroke and up to five times to obtain the desired mixing of fluid. At the end of the piston instroke, the valve-switching element 909 is further angularly actuated by its drive system to move its groove 914 above one of the two outlet apertures 912o so that the piston chamber is in fluid communication with one of the two outlet ports 920, 920′, whereupon fluid can be expelled out of the piston chamber 901′, through the corresponding piston aperture 912p, groove 914, outlet aperture 912o and outlet channel 9130, to one of the two outlet ports 920, 920′ (FIG. 65).

According to a variant of this embodiment as shown in FIG. 68, the surface of the disc 909 which comes to contact with the valve base member 907 of each valve system comprises a fluid seal element 907′ that is shaped to define a quasi-complete circular groove 914 that is arranged to overlap piston chamber apertures 912p. Said groove 914 further comprises a radial extension 914′ that is configured to overlap only one of the eight inlet and outlet apertures 912i, 912o. In this configuration, the valve base member 907 does not have any seal element.

Although, the fluid delivery system as described above comprises two pistons opposite to each other to ensure a virtually continuous flow delivery, the valve system comprises the valve base member and the valve-switching element can be adapted for a fluid delivery system comprises one piston only or more that two pistons. Besides, the valve system can be adapted so that any inlet port is selectable by imparting to-and-fro movements to the valve switching element relative to the valve base member so that the groove overlaps the corresponding inlet and piston chamber apertures.

The fluid delivery system as described in any embodiment can communicate by means of a wire or wirelessly to a remote control unit or a cellular mobile phone in order to control the amount of fluid released by said delivery system. It can further comprise monitor internal sensors such as pressure, force, temperature, humidity, or air sensors or any other type of sensor connected to the drive system. Such sensors can be directly or indirectly in communication with the fluid path. In addition, the fluid delivery system can also be connected by means of wire or wirelessly to external sensors such as a glucose sensor or any other type of sensor for providing information to the electronic in order to adapt the fluid delivery with the data measured by the sensor as for example in a closed loop system. The communication protocol between the drive system of the fluid pumping device and the remote control unit can be of any type. Either the drive system or the control unit can be programmed in order to adapt the fluid delivery accordingly to the patient inputs or sensor(s) data.

Additional elements such as vibrator or loudspeaker can be integrated to the drive system of the fluid pumping device in order to emit alarms for event such as an occlusion in the fluid line, a battery failure, a low level of drug in the reservoir or any other operational failure of the pump, including failure when any sensor detects a preset level which may present a risk to the patient.

Essential features of several embodiments of the invention reside in the valve-switching element that is a disc rotatably mounted on the valve base member and that preferably rotates through 360° during a pumping cycle.

Essential features according to other embodiments of the invention reside in the fact that the inlet and outlet cavities of the valve base member are aligned such that rectilinear edges of each inlet and outlet cavities are adjacent while the piston chamber cavity is arranged to have one rectilinear edge adjacent another rectilinear edge of both inlet and outlet cavities, and wherein the valve-switching element comprises a rectilinear groove arranged to move along and extend across the edge of the valve member that is adjacent to the inlet, outlet and piston chamber cavities.

Seal elements of the fluid pumping device according to any embodiment of the invention can be any sort of O-ring and/or any specific gasket. Besides, any part of the fluid pumping device can be machined or obtained by an injecting molding process. The pistons, the housing or the valve base member of the fluid pumping device can advantageously be integrally molded in a material presenting elastic properties to dispense with seal elements. Such integrally molded piece is widely used for sealing ceramic parts without the need of seal elements

Although the fluid delivery system as described in the different embodiments of the invention is particularly adapted to be used as an insulin pump, its essential components can also be scaled up to any size so that the fluid delivery system can operate in other fields. For instance, a high-pressure-resistance fluid delivery system operating over a wide range of flow rates can be obtained.

Elements and/or features of different illustrative embodiments may be combined with each other and/or substituted for each other within the scope of this disclosure and appended claims. For instance, the patch pump as described in the first embodiment can be adapted to incorporate the pump according to any embodiment.

1. A fluid pumping device comprising a pump housing
containing at least one piston chamber and at least one piston arranged to move back and forth inside the piston chamber, at least one inlet port and at least one outlet port arranged so that a fluid can be sucked through the inlet port into the piston chamber during an instroke of the piston and expelled from the piston chamber through the outlet port during an outstroke of the piston, the fluid pumping device further comprising a valve system, characterized in that the valve system comprises a valve-switching element that is movably mounted against a valve base member, said valve base member comprising at least one piston chamber aperture connected to the piston chamber and at least one inlet aperture and at least one outlet aperture connected respectively to the inlet and outlet ports of the fluid pumping device, wherein the valve-switching element comprises at least one groove or other recess arranged to move against the valve base member such that, said groove or recess creates a first communication allowing leakage between the inlet aperture and the piston chamber aperture so that fluid is sucked from the inlet port, through the groove or recess, into the piston chamber during at least a part of the piston instroke, while said groove or recess creates a second communication allowing leakage between the piston chamber aperture and the outlet aperture so that fluid is expelled out of the piston chamber, through the groove or recess and the outlet port during at least a part of the piston outstroke.

2. A fluid pumping device according to claim 1, wherein the groove or recess of the valve-switching element and the valve base member are movable relative to each other during piston instrokes and piston outstrokes, said groove or recess and said valve base member being configured so as to create said first and second communications when the valve-switching element moves relative to the valve base member so that fluid is sucked from the inlet port, through said groove, into the piston chamber during a piston instroke, while fluid is expelled out of the piston chamber through said groove and the outlet port during a piston outstroke.

3. A fluid pumping device according to claim 2, wherein the valve base member is shaped to define at least three cavities, each cavity comprising respectively the inlet aperture, the outlet aperture and the piston chamber aperture, (said cavities being referred to hereafter as the inlet, the outlet and the piston chamber cavities), and wherein the groove or recess of the valve-switching element
is arranged such that, during piston instrokes, said groove or recess moves along or across a part of the valve base member that is adjacent to the piston chamber cavity and the inlet cavity, thereby creating a first communication allowing leakage between said two cavities so that fluid is sucked from the inlet port, through the groove or recess, into the piston chamber during a piston instroke, while, during piston outstrokes, said groove or recess moves along or across a part of the valve base member that is adjacent to the piston chamber cavity
and the outlet cavity, thereby creating a second communication allowing leakage between said two
cavities so that fluid is expelled out of the piston chamber through the groove or recess and the outlet port during a piston outstroke.

4. A fluid pumping device according to claim 3, wherein the piston chamber is a hollow elongated part, and wherein the inlet and outlet ports are arranged on the housing of the fluid pumping device.

5. A fluid pumping device according to claim 3, wherein the valve-switching element is a disc rotatably mounted against the valve base member.

6. A fluid pumping device according to claim 2, wherein the valve-switching element is a disc rotatably mounted against the valve base member, said disc comprising a fluid seal element that is shaped to define said groove or recess.

7. A fluid pumping device according to claim 5, wherein the disc rotates through 360° during a pumping cycle.

8. A fluid pumping device according to claim 7, wherein the valve base member comprises a circular piston chamber cavity centered with respect to the rotating axis of the disc and bordered by arcuate inlet and outlet cavities that are symmetrically opposed with respect to the rotation axis of the disc, and wherein the disc comprises said groove which is substantially rectilinear, said disc being rotatably mounted on the valve base member so that during piston instrokes, the groove moves along and extends radially across a part of the valve base member that is adjacent to the piston chamber cavity and the arcuate inlet cavity, thereby creating a first communication allowing leakage between said two cavities so that fluid is sucked from the inlet port, through the groove, into the piston chamber during a piston instroke, while, during piston outstrokes, said groove moves along and extends radially across a part of the valve base member that is adjacent to the piston chamber cavity and the arcuate outlet cavity, thereby creating a second communication allowing leakage between said two cavities so that fluid is expelled out of the piston chamber, through the groove and the outlet port during a piston outstroke.

9. A fluid pumping device according to claim 7, wherein the pump housing contains a first and a second chamber, and a first and a second piston arranged to be linearly actuable to move back and forth inside their respective chambers, and wherein the valve base member comprises a first piston chamber cavity centered with respect to the rotating axis of the disc and connected to the first piston chamber, said first piston chamber cavity being bordered by arcuate inlet and outlet cavities which are connected respectively to the inlet and outlet port
of the fluid pumping device and which are symmetrically opposed with respect to the rotation axis of the disc, the valve base member further comprising a second piston chamber cavity encircling the arcuate inlet and outlet cavities, said second piston chamber cavity being connected to the second piston chamber.

10. A fluid pumping device according to claim 9, wherein the disc comprises a first and a second diametrically opposed substantially rectilinear groove, said disc being rotatably mounted against the valve base member such that, during instrokes of the first piston and outsrokes of the second piston, the first groove moves along and extends radially across a part of the valve base member that is adjacent to the first piston chamber cavity and the arcuate inlet cavity, thereby creating a first communication allowing leakage between said two cavities so that fluid is sucked from the inlet port, through the first groove into the first piston chamber during an instroke of the first piston, while the second groove moves along and extends
radially across a part of the valve base member that is adjacent to the arcuate outlet cavity and the second piston chamber cavity, thereby creating a second communication allowing leakage between said two cavities so that fluid is expelled out of the second piston chamber, through the second groove and the outlet port during an outstroke of the second piston.

11. A fluid pumping device according to claim 3, wherein the inlet cavity and the outlet cavity of the valve base member are aligned such that one rectilinear edge of each inlet and outlet cavities are adjacent while the piston chamber cavity is arranged to have one rectilinear edge adjacent another rectilinear edge of both inlet and outlet cavities, and wherein the valve-switching element comprises a groove arranged to move along and extend across a part of the valve member that is adjacent to the inlet, outlet and piston chamber cavities.

12. A fluid pumping device according to claim 11, wherein the inlet and the outlet cavities are substantially rectangular and are adjacent to each other along their common longitudinal axis which is oriented in a direction perpendicular to the movement of the piston, while the piston chamber cavity is arranged to have its rectilinear edge adjacent to one lateral side of both inlet and outlet cavities.

13. A fluid pumping device according to claim 12, wherein the valve-switching element of the valve system has a substantially flat surface that is mounted to rest on the valve base member to allow relative to-and-fro linear movements between the valve-switching element and the valve base member in a direction perpendicular to the movement of the piston, the groove being arranged on the surface of the valve-switching element such that, during piston instrokes, said groove moves along and extends across a part of the valve base member that is adjacent to the inlet cavity and the chamber cavity, thereby creating a first communication allowing leakage between said cavities so that fluid is sucked into the piston chamber during the piston instroke, while, during piston outstrokes, said groove moves along and extends across a part of the valve base member that is adjacent to the outlet cavity and the chamber cavity, thereby creating a second communication allowing leakage between said cavities so that fluid is expelled out of the piston chamber through the outlet port of the fluid pumping device during a piston outstroke.

14. A fluid pumping device according to claim 11, wherein each of the valve-switching element and the piston comprises a guiding element having a substantially rectangular aperture arranged to be superposed when the valve-switching element is mounted on the valve base member of the fluid pumping device, such that a part of a drive system can protrude through the two apertures of said guiding elements, said apertures being arranged to have their respective longitudinal axes perpendicular to each other.

15. A fluid pumping device according to claim 3, wherein the valve base member comprises fluid seal elements that are shaped to define or to fit over the inlet, outlet and piston chamber cavities.

16. A fluid pumping device according to claim 3, wherein the valve base member is a moulded or over-moulded part, which comprises the inlet, outlet and piston chamber cavities.

17. A drive system for driving the fluid pumping device according to claim 1, wherein the drive system is adapted to impart relative movements between the valve-switching element and the valve base member of the fluid pumping device.

18. A drive system for driving the fluid pumping device according to claim 2, comprising driving means to impart a rotating movement to the valve-switching element and a to- and-fro linear movement to the piston(s) of the fluid pumping device.

19.-23. (canceled)

24. A drive system for driving the fluid pumping device according to claim, comprising means to impart combined rotating and to-and-fro linear movements to the valve-switching element.

25. A method for manufacturing a fluid pumping device according to claim 15, by an injection moulding process which comprises the following steps:
(a) injecting a mouldable plastic material capable of forming a substantially rigid element into a mould cavity assembly for obtaining the housing of the fluid pumping device, said housing comprising a part adapted to receive the valve base member;
(b) placing a seal mould matrix designed to reproduce the inlet, outlet and piston chamber(s) cavities on said part; and
(c) injecting into said matrix a mouldable rubber-elastic material in a flowable state, the rubber-elastic material polymerizing in the mould matrix while being bonded to the housing of the fluid pumping device to form the valve base member.

26. A method for manufacturing a fluid pumping device according to claim 15, wherein the housing of the fluid pumping device is obtained by an injection moulding process consisting of injecting a mouldable plastic material capable of forming a substantially rigid element into a mould cavity assembly for obtaining the housing of the fluid pumping device, said housing comprising a part adapted to receive the valve base member; and wherein the valve base member is obtainable by a separate injecting moulding process, and is added on said part.

27.-30. (canceled)

31. A fluid delivery system comprising the fluid pumping device according to claim 1, wherein said delivery system comprises a plurality of inlet ports and at least one outlet port, wherein each of the inlet and outlet ports is independently selectable to be in fluid communication with the piston chamber, the valve base member comprising for this purpose a corresponding plurality of inlet and outlet apertures, each inlet aperture being connected to the corresponding inlet port of the fluid delivery system by means of an inlet channel, while each outlet aperture is connected to the corresponding outlet port by means of an outlet channel, the valve base member further comprising at least one piston chamber aperture that communicates with the piston chamber, wherein any inlet or outlet port is selectable by imparting a movement to the valve switching element relative to the valve base member so that the groove overlaps the corresponding inlet or outlet aperture and the piston chamber aperture.

32. A fluid delivery system according to claim 31, wherein the valve-switching element is a disc that is rotatably mounted on the valve base member, and wherein the plurality of inlet and outlet apertures are arranged on said valve base member in a circular pattern.

33. A fluid delivery system according to claim 32, wherein the disc comprises a fluid seal element that is shaped to define a circular groove arranged to permanently overlap the at least one piston chamber aperture, said groove having a radial extension configured to overlap one of the inlet or outlet apertures.
